(19) United States
(12) Patent Application Publication
(10) Pub. No.: US 2009/0236975 A1
(43) Pub. Date: Sep. 24, 2009

(54) SILICON-CONTAINING COMPOUND AND ORGANIC ELECTROLUMINESCENT DEVICE UTILIZING THE SAME

(75) Inventor: Mitsunori Ito, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignee: IDEMITSU KOSAN CO., LTD., Tokyo (JP)

(21) Appl. No.: 12/299,967

(22) PCT Filed: May 8, 2007
(86) PCT No.: PCT/JP2007/059499

§ 371 Date: Feb. 13, 2009

(30) Foreign Application Priority Data
May 9, 2006 (JP) 2006-129849

(51) Int. Cl. H01J 1/62; C07F 7/08

(52) U.S. Cl. 313/504; 556/489

(57) ABSTRACT

Provided are a silicon compound of a specified structure having a substituted silyl group and an organic electroluminescence device composed of one or more organic thin film layers including at least a light emitting layer, the organic thin film layer being interposed between a cathode and an anode, in which at least one layer of the organic thin film layers contains the silicon compound alone or as a component of mixture. Thus, there are provided an organic electroluminescence device capable of obtaining a high luminous efficiency, a high color purity and a long lifetime, and a novel silicon compound for realization thereof.

### TECHNICAL FIELD

The present invention relates to a silicon-containing compound and an organic electroluminescence (hereinafter, which may sometimes be abbreviated as EL) device using the compound, and more particularly to an organic EL device exhibiting a great efficiency of light emission, exhibiting a high color purity and having a long life; and a silicon-containing compound for realizing the device.

### BACKGROUND ART

An organic EL device is a spontaneous light emitting device which utilizes the phenomenon that a fluorescent substance emits light by energy of recombination of holes injected from an anode and electrons injected from a cathode when an electric field is applied. Since an organic EL device of the laminate type driven under a low electric voltage was reported by C. W. Tang et al. of Eastman Kodak Company (C. W. Tang and S. A. Vanslyke, Applied Physics Letters, Volume 51, Page 913, 1987), many studies have been conducted on organic EL devices using organic materials as the constituting materials. Tang et al. used tris(8-quinolinol aluminum) for the light emitting layer and a triphenyldiamine derivative for the hole transporting layer. Advantages of the laminate structure are that the efficiency of hole injection into the light emitting layer can be increased, that the efficiency of forming excitons which are formed by blocking and recombining electrons injected from the cathode can be increased, and that the excitons formed in the light emitting layer can be confined. As described above, for the structure of the organic EL device, a two-layered structure having a hole transporting (injecting) layer and an electron-transporting light emitting layer and a three-layered structure having a hole transporting (injecting) layer, a light emitting layer, and an electron-transporting (injecting) layer are well known. In order to increase the efficiency of recombination of injected holes and electrons in the devices of the laminate type, the structure of the device and the process for forming the device have been studied.

Further, as the light emitting material, chelate complexes such as tris(8-quinolinolato)aluminum complexes, coumarin derivatives, tetraphenylbutadiene derivatives, bisstyrylarylene derivatives, and oxadiazole derivatives are known. It is reported that light in the visible region ranging from blue light to red light can be obtained by using those light emitting materials, and development of a device exhibiting color images is expected (for example, Patent Documents 1 to 3).

In recent years, a large number of investigations have been conducted on the use of a phosphorescent compound as a light emitting material and the use of energy in a triplet state in EL light emission. A group of Princeton University has reported that an organic light emitting device using an iridium complex as a light emitting material shows high luminous efficiency (Non-patent Document 1). In addition to the organic EL device using a low molecular weight material as described above, an organic EL device using a conjugated polymer has been reported by a group of Cambridge University (Non-patent Document 2). In this report, light emission has been confirmed from a monolayer of polyphenylene vinylene (PPV) formed in a coating system.

Recent advances in organic EL device are remarkable, and characteristics of the organic EL device allow formation of a thin and lightweight light-emitting device with high luminance under application of a low voltage, wide range of emission wavelengths, and high-speed response, thereby suggesting the possibility of extensive uses.

In association with the significant progress of an organic light emitting device, performance requested of a light emitting material has been growing, and Patent Documents 4 and 5 each discloses a pyrene compound using fluorene as a linker. Further, Patent Document 6 discloses an anthracene compound having two substituted silyl groups. However, the anthracene compound has problems of low efficiency of light emission and does not achieve to satisfy the characteristic required for the light emitting material needing an optical output of high luminance or a high conversion efficiency. In addition, a light emitting material which takes durability against, for example, a change over time due to long-term use and deterioration due to, for example, an atmospheric gas containing oxygen or moisture, and application to a full-color display or the like into consideration; and emits blue, green, or red light with a high color purity, has been desired.

Patent Document 1: JP 08-239655 A

Patent Document 2: JP 07-138561 A

Patent Document 3: JP 03-200889 A

Patent Document 4: JP 2004-83481 A

Patent Document 5: JP 2004-43349 A

Patent Document 6: JP 2006-28175 A

Non-patent Document 1: Nature, 395,151 (1998)

Non-patent Document 2: Nature, 347,539 (1990)

### DISCLOSURE OF THE INVENTION

### Problems to be Solved by the Invention

The present invention has been made to overcome the above problems and has an object of providing an organic EL device with high efficiency of light emission, high purity and long lifetime, and an object of providing a silicon-containing compound realizing it.

### Means for Solving the Problem

As a result of intensive researches and studies to achieve the above object by the present inventors, it was found that an employment of a silicon-containing compound represented by the following general formula (1) as a material, as a material for the organic EL device achieves the above objects, resultantly completing the present invention.

In the present invention, the silicon-containing compounds include a silicon-containing anthracene derivative and a silicon-containing pyrene derivative.

In other words, the present invention provides the silicon-containing compound represented by the following general formula (1) and having a constitution of (1-1), (1-2), (1-3), (1-4) or (1-5).

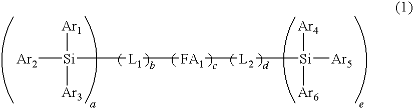

where: FA₁ represents a substituted or unsubstituted fused ring residue having 8 to 50 ring carbon atoms; L₁, L₂ and Ar₁ to Ar₆ may be independently identical to or different from each other, and independently represent a substituted or unsubstituted aromatic hydrocarbon group having 6 to 50 ring carbon atoms, a substituted or unsubstituted aromatic heterocyclic group having 3 to 50 ring carbon atoms, a substituted or unsubstituted fused aromatic group having 8 to 50 ring carbon atoms, or a substituted or unsubstituted alkyl group having 1 to 10 carbon atoms; a, b, d and e each represent an integer of 0 to 6; c represents an integer of 1 to 6; and a+e≧1
(1-1) with the proviso that when FA₁ represents an anthrylene group and a=e=1, a case where both L₁ and L₂ are simultaneously phenylene groups is excluded.
(1-2) with the proviso that when FA₁ represents an anthrylene group or a naphthylene group and a=e=1, a case where both L₁ and L₂ are simultaneously phenylene groups is excluded.
(1-3) with the proviso that when FA₁ represents a fused ring residue having 8 to 20 ring carbon atoms and a=e=1, a case where both L₁ and L₂ are simultaneously phenylene groups is excluded.
(1-4) with the proviso that when FA₁ represents a fused ring residue having 8 to 20 ring carbon atoms [excluding an anthrylene group and a naphthylene group] and a=e=1, both L₁ and L₂ are simultaneously phenylene groups.
(1-5) with the proviso that when FA₁ represents a pyrenylene group and a=e=1, both L₁ and L₂ are simultaneously phenylene groups.

Further, the present invention provides an organic EL device which is composed of one or more organic thin film layers including at least one light emitting layer interposed between a cathode and an anode, wherein at least one of the organic thin film layers includes the silicon-containing compound alone or as a component of a mixture.

### EFFECT OF THE INVENTION

The organic EL device employing the silicon-containing compound of the present invention as a material for the organic EL device has an enhanced efficiency of light emission, a high color purity and a prolonged lifetime.

### PREFERRED EMBODIMENT TO CARRY OUT THE INVENTION

The present invention provides the silicon-containing compound represented by the following general formula (1) and having a constitution of (1-1), (1-2), (1-3), (1-4) or (1-5).

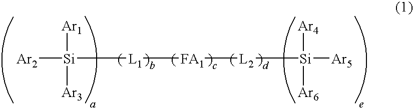

(1-1) When FA₁ represents an anthrylene group and a=e=1, a case where both L₁ and L₂ are simultaneously phenylene groups is excluded.
(1-2) When FA₁ represents an anthrylene group or a naphthylene group and a=e=1, a case where both L₁ and L₂ are simultaneously phenylene groups is excluded.
(1-3) When FA₁ represents a fused ring residue having 8 to 20 ring carbon atoms and a=e=1, a case where both L₁ and L₂ are simultaneously phenylene groups is excluded.
(1-4) When FA₁ represents a fused ring residue having 8 to 20 ring carbon atoms [excluding an anthrylene group and a naphthylene group] and a=e=1, both L₁ and L₂ are simultaneously phenylene groups.
(1-5) When FA₁ represents a pyrenylene group and a=e=1, both L₁ and L₂ are simultaneously phenylene groups.

In the general formula (1), a and e each independently represent an integer of 0 to 6, preferably 1 to 4, and further preferably 1 or 2. In the formula, b and d each independently represent an integer of 0 to 6, preferably 0 to 4, and further preferably 0 to 2. In the formula, c represents an integer of 0 to 6, preferably 1 to 4, and further preferably 1 to 3.

In the formula, a condition a+e≧1 should be satisfied, and it is preferable that a+e is 1 to 4, further preferably 1 or 2.

In the present invention, it is preferable that the silicon-containing compound represented by the general formula (1) corresponds to the one represented by the following general formula (2) [a=b=c=d=1 in the general formula (1)]:

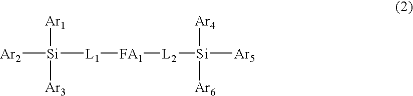

In the present invention, it is preferable that the silicon-containing compound represented by the general formula (1) corresponds to the one represented by any one of the following general formulae (3) to (6).

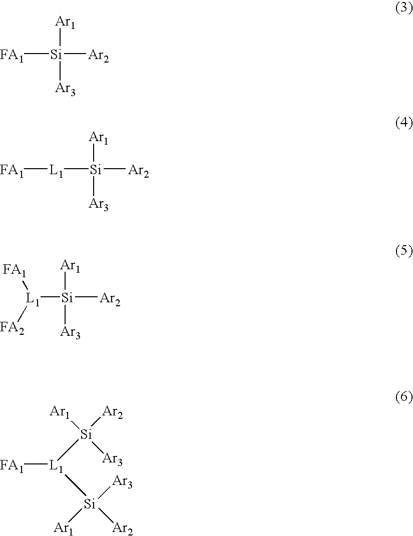

In the general formulae (1) to (6), FA₁ and FA₂ each independently represent a substituted or unsubstituted fused ring residue having 8 to 50 (preferably 10 to 36) ring carbon atoms. Examples of the fused ring residue having 8 to 50 ring carbon atoms include naphthalene, phenanthrene, pyrene, anthracene, tetracene, coronene, chrysene, fluorene, perylene, benzanthracene, pentacene, dibenzo anthracene, benzopyrene, benzofluorene, fluoranthene, benzofluoranthene, naphthylfluoranthene, dibenzofluorene, dibenzopyrene, dibenzofluoranthene, naphthacene, acenaphthylfluoranthene, bentzanthracene, benzfluorene, fluorescein, phthaloperylene, naphthaloperylene, perinone, phthaloperinone, naphthaloperinone, diphenylbutadiene, tetraphenylbutadiene, coumarin, oxadiazole, aldazine, bisbenzoxazoline, bisstyryl, pyrazine, cyclopentadiene, imine, diphenylethylene, vinyl anthracene, diaminocarbazole, pyran, thiopyran, polymethine, merocyanine, imidazole chelate compound, oxynoid compound, quinacridon, rubrene, stilbene based derivative and residue of the compound having a skeleton of fluorescent dye with the following structure. Among those, the residue of the compound having skeleton of naphthalene, phenanthrene, pyrene, anthracene, tetracene, coronene, chrysene, fluorene, perylene, benzanthracene, pentacene, dibenzo anthracene, benzopyrene, benzofluorene, fluoranthene, benzofluoranthene, naphthyl fluoranthene, dibenzofluorene, dibenzopyrene, dibenzofluoranthene, naphthacene or acenaphthyl fluoranthene is preferable, the residue of the compound having skeleton of pyrene, anthracene or fluoranthene is more preferable and the residue of the compound having skeleton of anthracene or pyrene is particularly preferable.

In the structure (1-1) of the general formula (1), it is preferable that the fused ring residue having 8 to 50 ring carbon atoms represented by FA₁ corresponds to a residue of a compound having an anthracene skeleton, with the proviso that when a=e=1, a case where L₁ and L₂ are simultaneously phenylene groups is excluded. Also in the general formulae (2) to (6), it is preferable that the fused ring residue having 8 to 50 ring carbon atoms represented by FA₁ and/or FA₂ corresponds to a residue of a compound having an anthracene skeleton, with the proviso that a case where L₁ and L₂ in the general formula (2) are simultaneously phenylene groups is excluded.

In the structure (1-3) of the general formula (1), it is preferable that the fused ring residue having 8 to 50 ring carbon atoms represented by FA₁ in the general formula (1) corresponds to a residue of a compound having a pyrene skeleton, with the proviso that when a=e=1, a case where L₁ and L₂ are simultaneously phenylene groups is excluded. Also in the general formulae (2) to (6), it is preferable that the fused ring residue having 8 to 50 ring carbon atoms represented by FA₁ and/or FA₂ corresponds to a residue of a compound having a pyrene skeleton, with the proviso that a case where L₁ and L₂ in the general formula (2) are simultaneously phenylene groups is excluded.

In the structure (1-5) of the general formula (1), it is preferable that the fused ring residue having 8 to 50 ring carbon atoms represented by FA₁ in the general formula (1) corresponds to a residue of a compound having a pyrene skeleton, with the proviso that when a=e=1, L₁ and L₂ are simultaneously phenylene groups. Also in the general formulae (2) to (6), it is preferable that the fused ring residue having 8 to 50 ring carbon atoms represented by FA₁ and/or FA₂ corresponds to a residue of a compound having a pyrene skeleton, with the proviso that L₁ and L₂ in the general formula (2) are simultaneously phenylene groups.

Preferable examples of the structure having the above-mentioned skeletons are as follows:

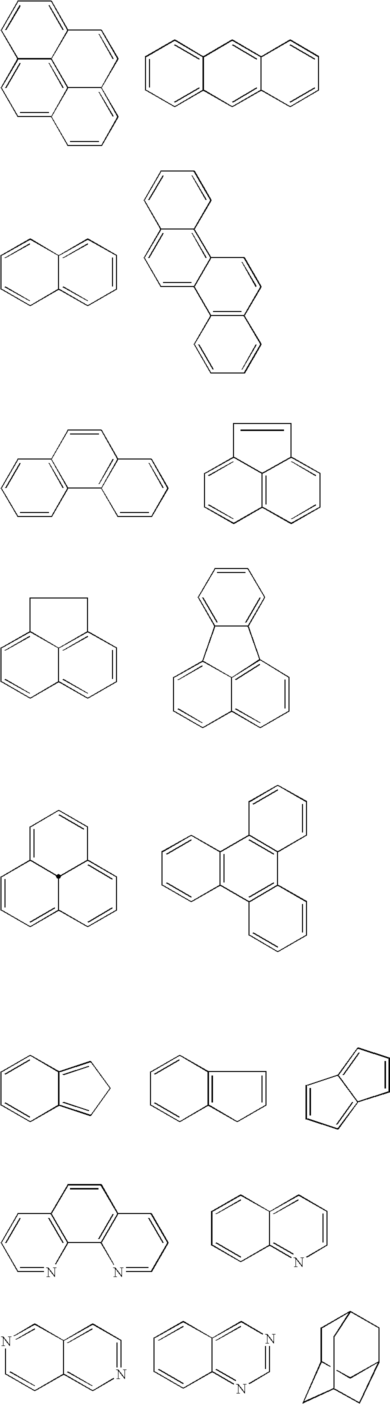

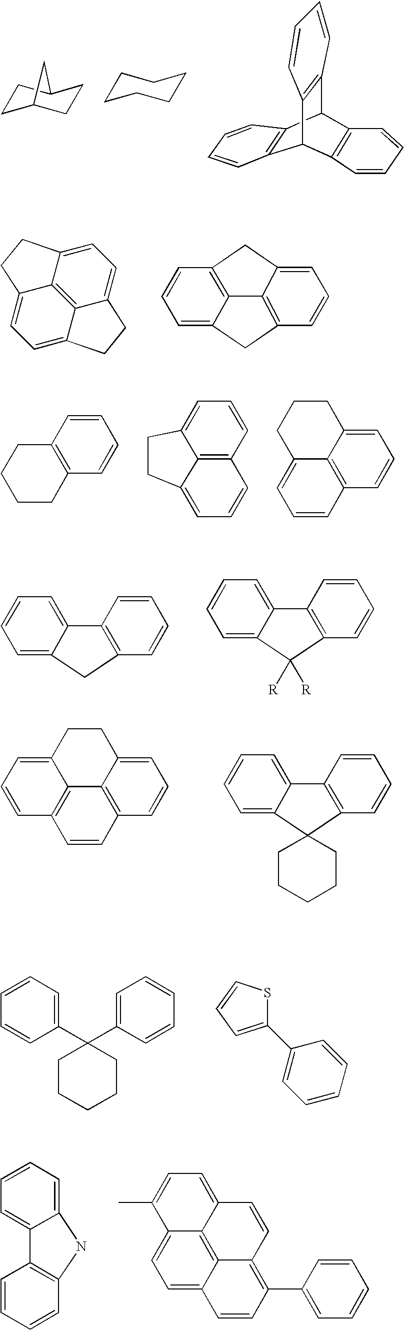

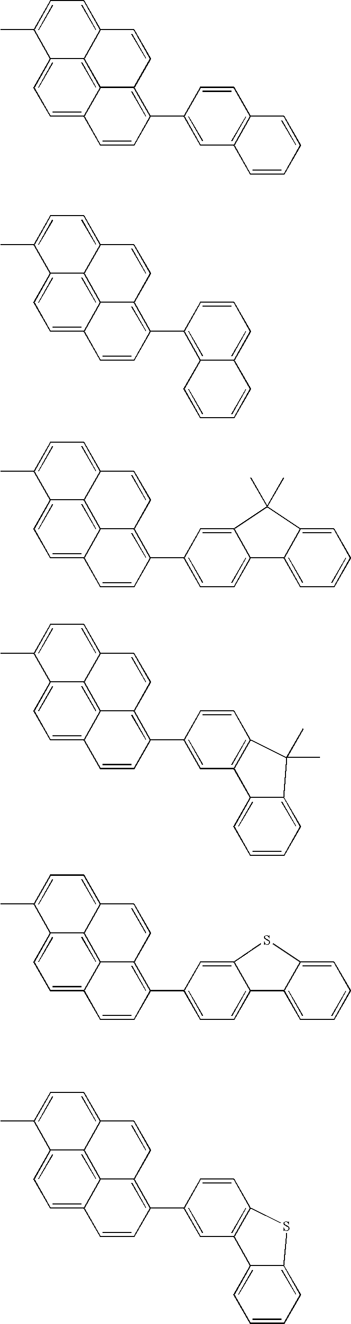

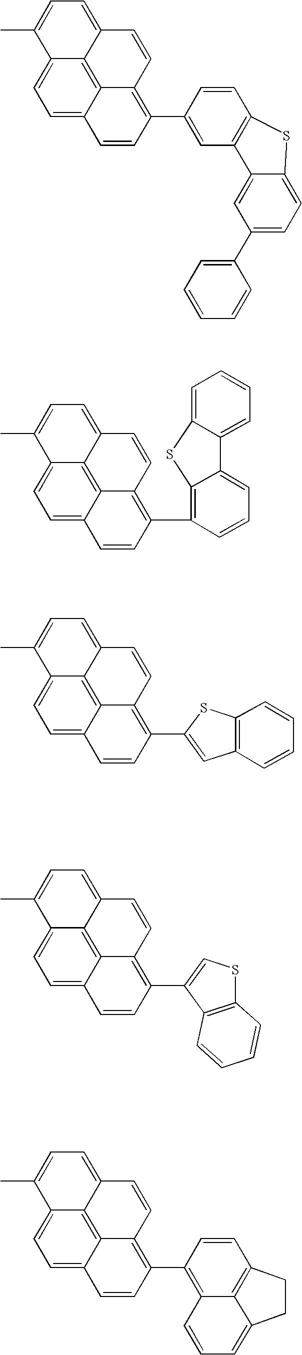

Examples of the structure having the pyrene skeleton are as follows:

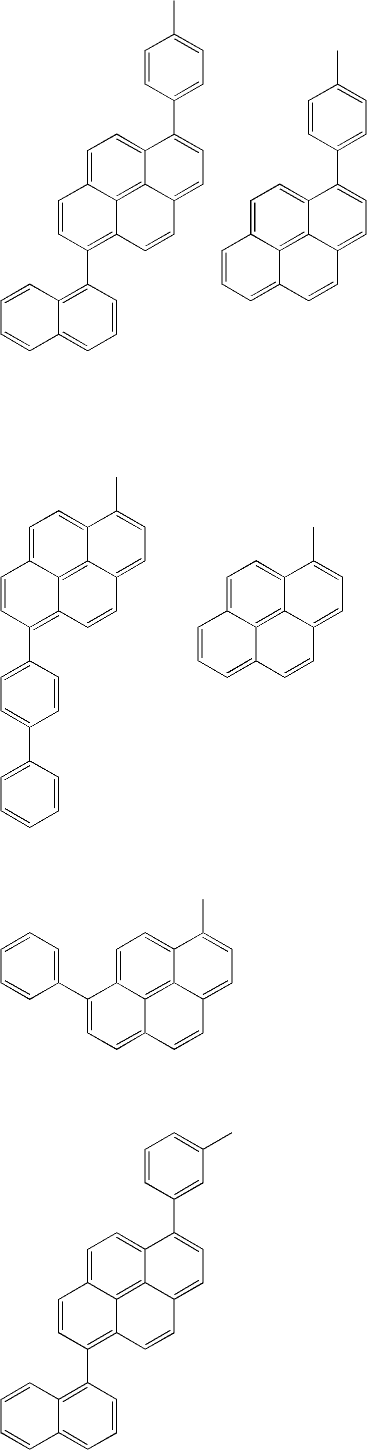

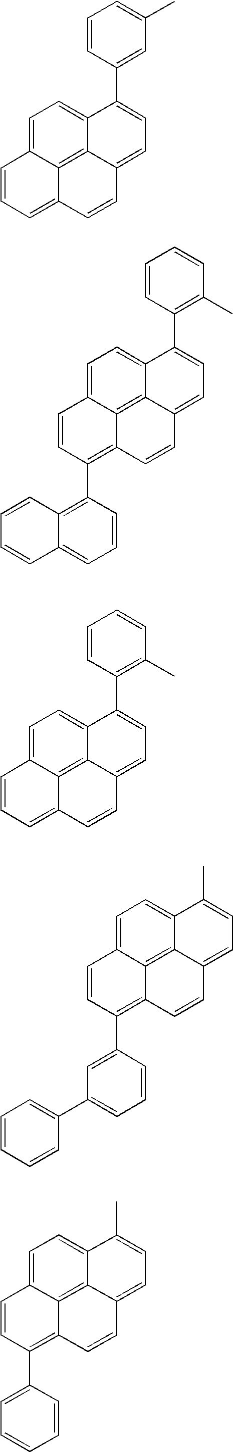

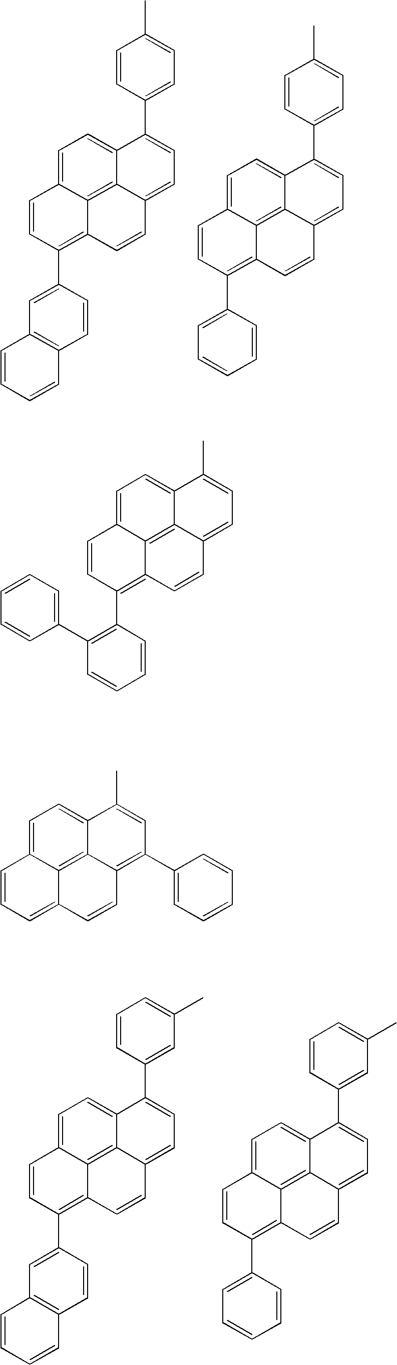

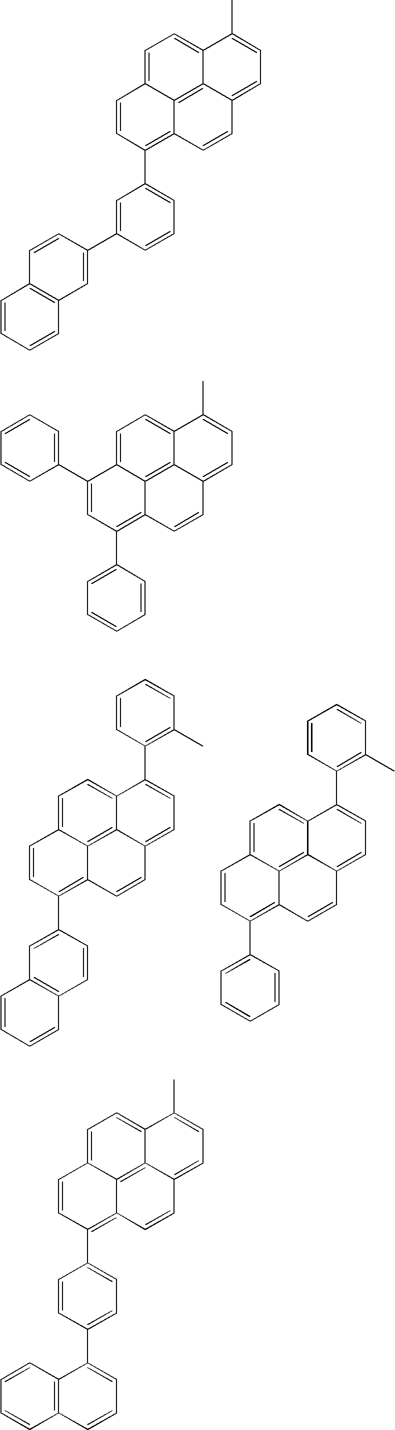

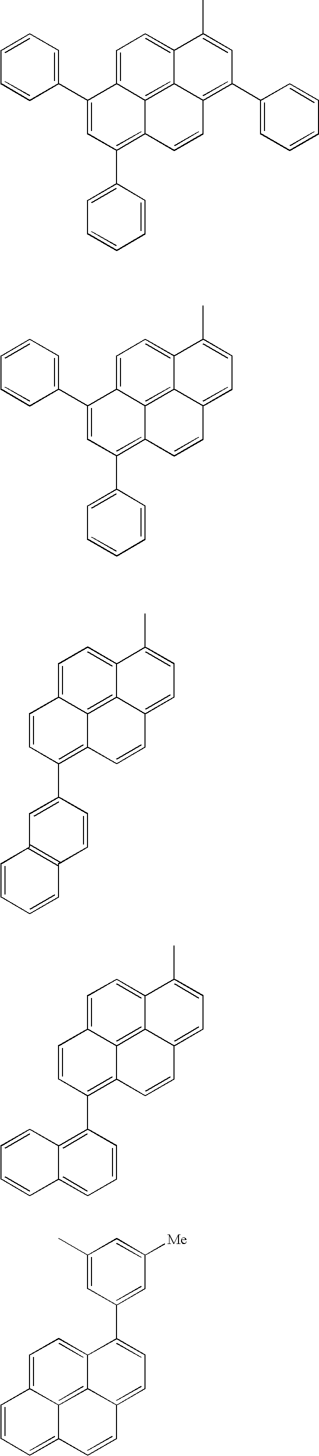

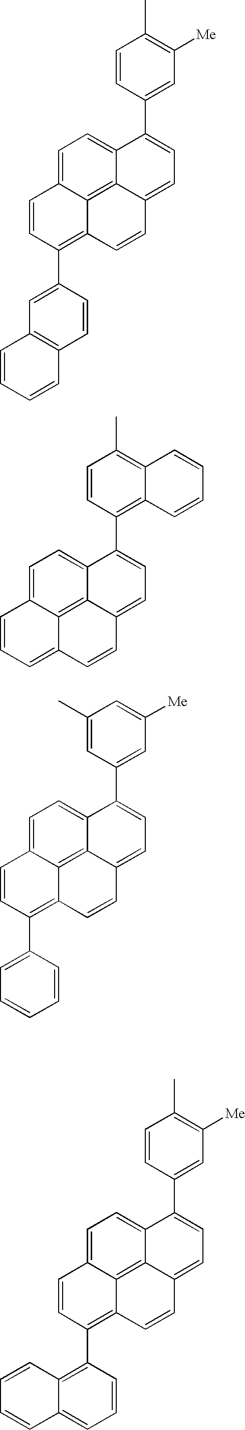

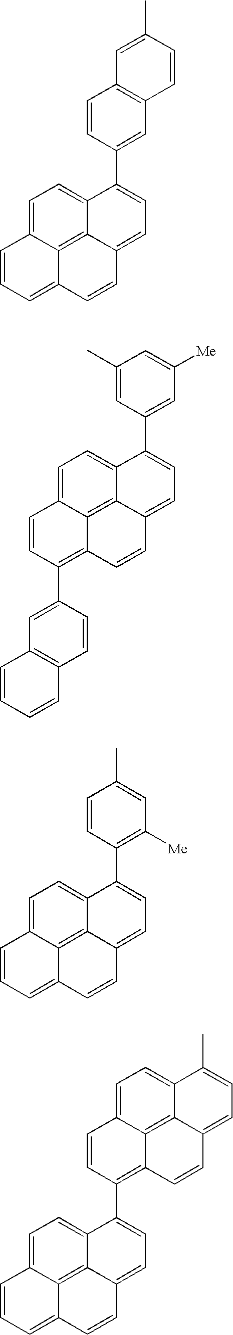

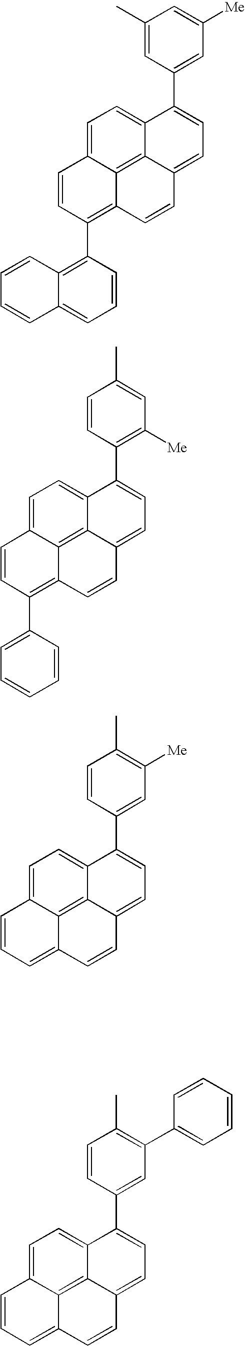

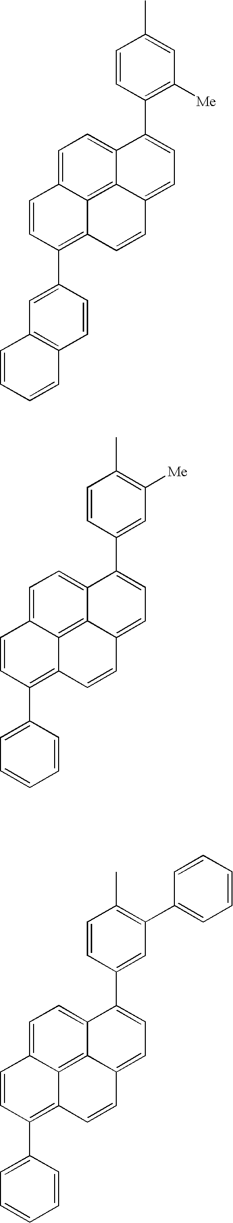

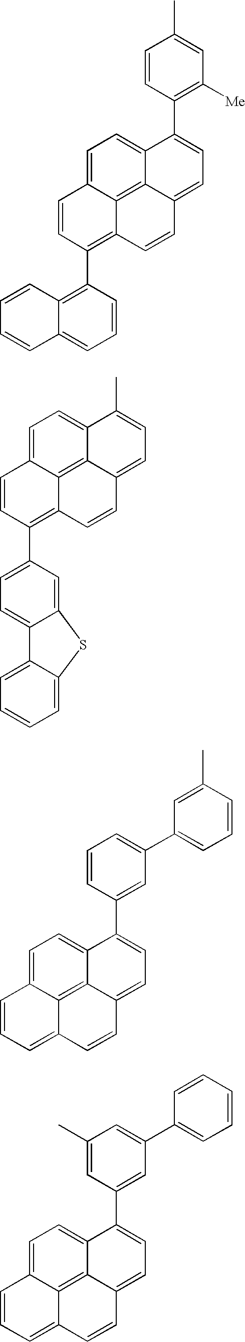

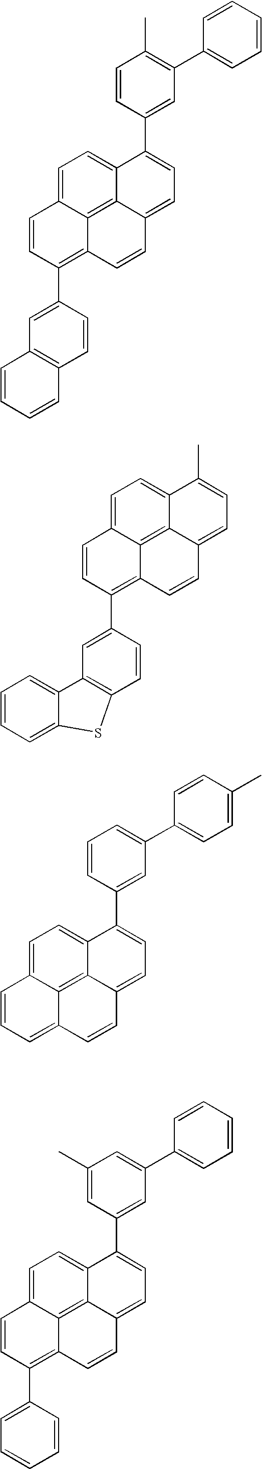

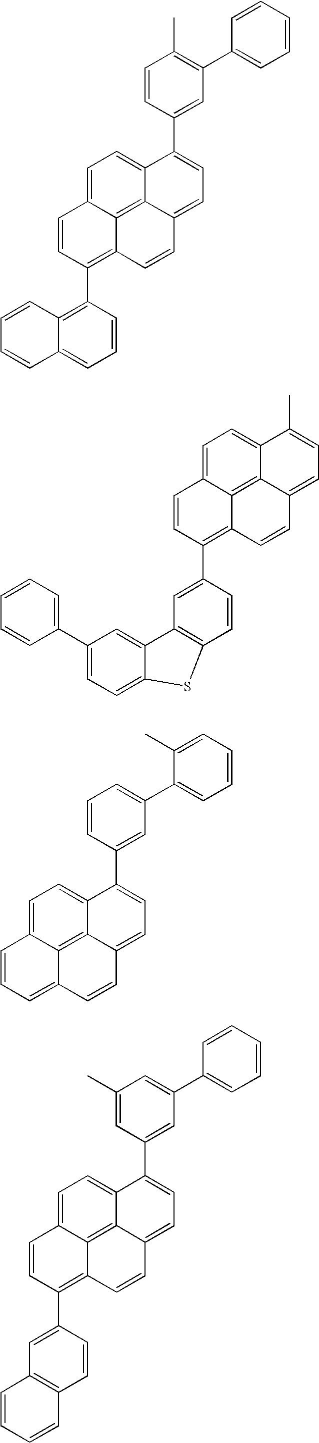

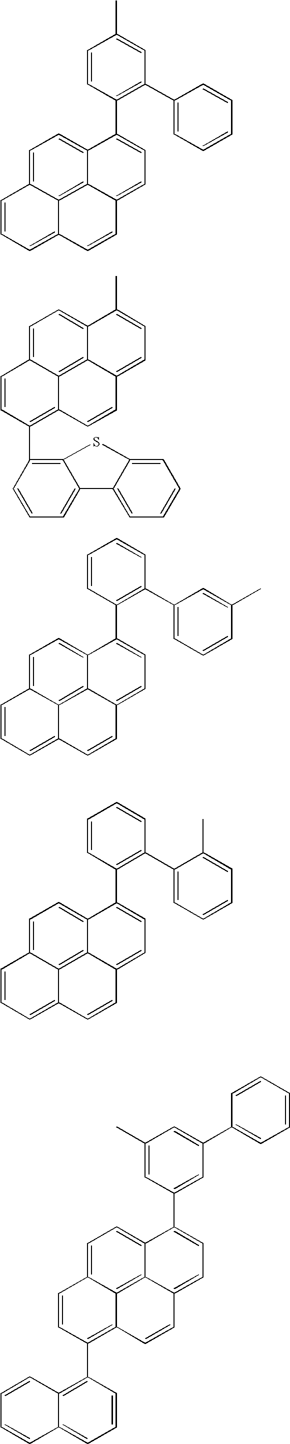

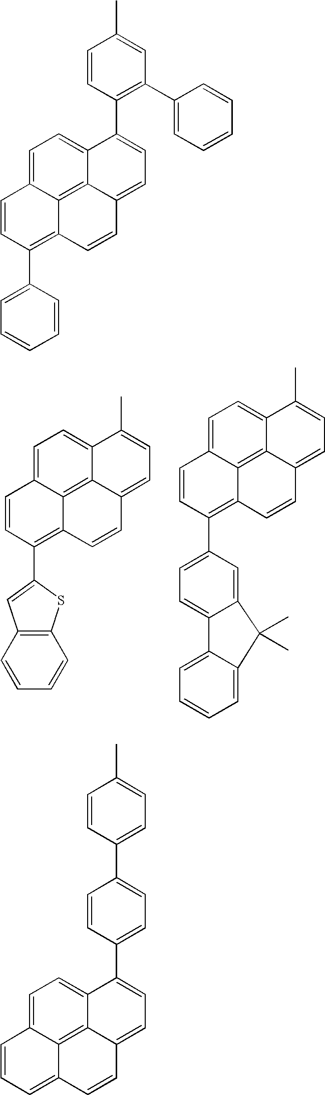

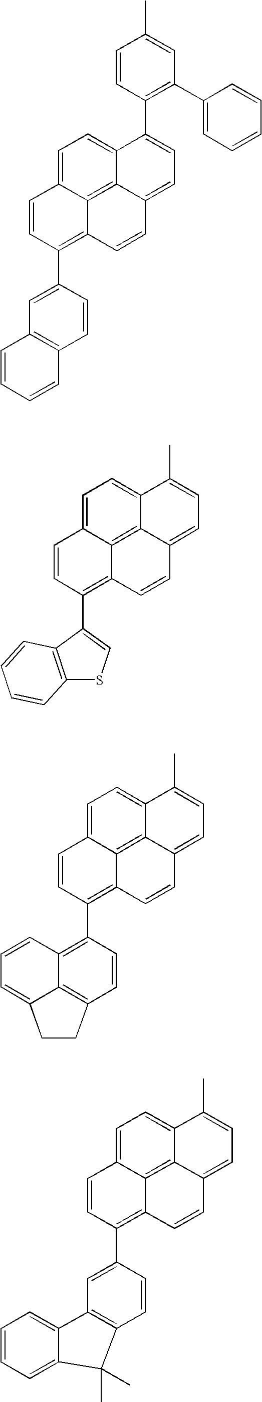

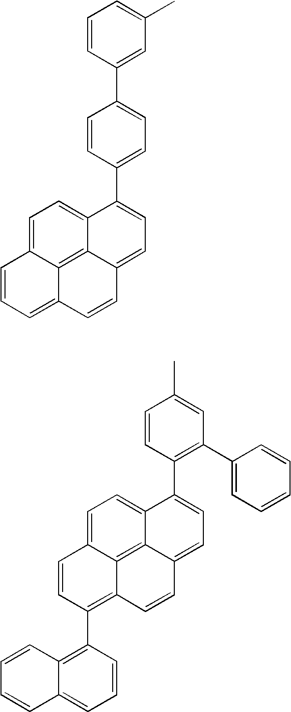

In the general formulae (1) to (6), L₁, L₂ and Ar₁ to Ar₆ may be independently identical to or different from each other, and each independently represent a substituted or unsubstituted aromatic hydrocarbon group having 6 to 50 (preferably 6 to 36) ring carbon atoms, a substituted or unsubstituted aromatic heterocyclic group having 3 to 50 (preferably 3 to 36) ring carbon atoms, a substituted or unsubstituted fused aromatic group having 8 to 50 (preferably 10 to 36) ring carbon atoms, or a substituted or unsubstituted alkyl group having 1 to 10 (preferably 1 to 4) carbon atoms.

Examples of the fused aromatic group having 8 to 50 ring carbon atoms represented by L₁, L₂, and Ar₁ to Ar₆ include the identical examples of the fused ring residue having 8 to 50 ring carbon atoms represented by FA₁ and FA₂.

Examples of the aromatic hydrocarbon group having 6 to 50 ring carbon atoms represented by L₁, L₂, and Ar₁ to Ar₆ include phenyl group, naphthyl group (1-naphthyl group, 2-naphthyl group), anthryl group (1-anthryl group, 2-anthryl group, 9-anthryl group), phenanthryl group (1-phenanthryl group, 2-phenanthryl group, 3-phenanthryl group, 4-phenanthryl group, 9-phenanthryl group), naphthacenyl group (1-naphthacenyl group, 2-naphthacenyl group, 9-naphthacenyl group), pyrenyl group (1-pyrenyl group, 2-pyrenyl group, 4-pyrenyl group), biphenylyl group (2-biphenylyl group, 3-biphenylyl group, 4-biphenylyl group), terphenyl-yl group (p-terphenyl-4-yl group, p-terphenyl-3-yl group, p-terphenyl-2-yl group, m-terphenyl-4-yl group, m-terphenyl-3-yl group, m-terphenyl-2-yl group), tolyl group (o-tolyl group, m-tolyl group, p-tolyl group), butylphenyl group (p-t-butylphenyl group), p-(2-phenylpropyl) phenyl group, methyl-naphthyl group (3-methyl-2-naphthyl group, 4-methyl-1-naphthyl group), methyl-anthryl group (4-methyl-1-anthryl group), methylbiphenylyl group (4′-methylbiphenyl-yl group), and butyl-terphenyl-yl group (4″-t-butyl-p-terphenyl-4-yl group). Preferable examples are phenyl group, naphthyl group and pyrenyl group.

Examples of the aromatic heterocyclic group having 6 to 50 ring carbon atoms represented by L₁, L₂, and Ar₁ to Ar₆ include pyrrolyl group (1-pyrrolyl group, 2-pyrrolyl group, 3-pyrrolyl group), pyrazinyl group, pyridinyl group (2-pyridinyl group, 3-pyridinyl group, 4-pyridinyl group), indolyl group (1-indolyl group, 2-indolyl group, 3-indolyl group, 4-indolyl group 5-indolyl group, 6-indolyl group, 7-indolyl group), iso indolyl group (1-iso indolyl group, 2-iso indolyl group, 3-iso indolyl group, 4-iso indolyl group, 5-iso indolyl group, 6-iso indolyl group, 7-iso indolyl group), furyl group (2-furyl group, 3-furyl group), benzofuranyl group (2-benzofuranyl group, 3-benzofuranyl group, 4-benzofuranyl group, 5-benzofuranyl group, 6-benzofuranyl group, 7-benzofuranyl group), iso benzofuranyl group (1-iso benzofuranyl group, 3-iso benzofuranyl group, 4-iso benzofuranyl group, 5-iso benzofuranyl group, 6-iso benzofuranyl group, 7-iso benzofuranyl group), quinolyl group (2-quinolyl group, 3-quinolyl group, 4-quinolyl group, 5-quinolyl group, 6-quinolyl group, 7-quinolyl group, 8-quinolyl group), isoquinolyl group (1-isoquinolyl group, 3-isoquinolyl group, 4-isoquinolyl group, 5-isoquinolyl group, 6-isoquinolyl group, 7-isoquinolyl group, 8-isoquinolyl group), quinoxalinyl group (2-quinoxalinyl group, 5-quinoxalinyl group, 6-quinoxalinyl group), carbazolyl group (1-carbazolyl group, 2-carbazolyl group, 3-carbazolyl group, 4-carbazolyl group, 9-carbazolyl group), phenanthridinyl group (1-phenanthridinyl group, 2-phenanthridinyl group, 3-phenanthridinyl group, 4-phenanthridinyl group, 6-phenanthridinyl group, 7-phenanthridinyl group, 8-phenanthridinyl group, 9-phenanthridinyl group, 10-phenanthridinyl group), acridinyl group (1-acridinyl group, 2-acridinyl group, 3-acridinyl group, 4-acridinyl group, 9-acridinyl group), phenanthroline-yl group (1,7-phenanthroline-2-yl group, 1,7-phenanthroline-3-yl group, 1,7-phenanthroline-4-yl group, 1,7-phenanthroline-5-yl group, 1,7-phenanthroline-6-yl group, 1,7-phenanthroline-8-yl group, 1,7-phenanthroline-9-yl group, 1,7-phenanthroline-10-yl group, 1,8-phenanthroline-2-yl group, 1,8-phenanthroline-3-yl group, 1,8-phenanthroline-4-yl group, 1,8-phenanthroline-5-yl group, 1,8-phenanthroline-6-yl group, 1,8-phenanthroline-7-yl group, 1,8-phenanthroline-9-yl group, 1,8-phenanthroline-10-yl group, 1,9-phenanthroline-2-yl group, 1,9-phenanthroline-3-yl group, 1,9-phenanthroline-4-yl group, 1,9-phenanthroline-5-yl group, 1,9-phenanthroline-6-yl group, 1,9-phenanthroline-7-yl group, 1,9-phenanthroline-8-yl group, 1,9-phenanthroline-10-yl group, 1,10-phenanthroline-2-yl group, 1,10-phenanthroline-3-yl group, 1,10-phenanthroline-4-yl group, 1,10-phenanthroline-5-yl group, 2,9-phenanthroline-1-yl group, 2,9-phenanthroline-3-yl group, 2,9-phenanthroline-4-yl group, 2,9-phenanthroline-5-yl group, 2,9-phenanthroline-6-yl group, 2,9-phenanthroline-7-yl group, 2,9-phenanthroline-8-yl group, 2,9-phenanthroline-10-yl group, 2,8-phenanthroline-1-yl group, 2,8-phenanthroline-3-yl group, 2,8-phenanthroline-4-yl group, 2,8-phenanthroline-5-yl group, 2,8-phenanthroline-6-yl group, 2,8-phenanthroline-7-yl group, 2,8-phenanthroline-9-yl group, 2,8-phenanthroline-10-yl group, 2,7-phenanthroline-1-yl group, 2,7-phenanthroline-3-yl group, 2,7-phenanthroline-4-yl group, 2,7-phenanthroline-5-yl group, 2,7-phenanthroline-6-yl group, 2,7-phenanthroline-8-yl group, 2,7-phenanthroline-9-yl group, 2,7-phenanthroline-10-yl group), phenazinyl group (1-phenazinyl group, 2-phenazinyl group), phenothiazinyl group (1-phenothiazinyl group, 2-phenothiazinyl group, 3-phenothiazinyl group, 4-phenothiazinyl group, 10-phenothiazinyl group), phenoxazinyl group (1-phenoxazinyl group, 2-phenoxazinyl group, 3-phenoxazinyl group, 4-phenoxazinyl group, 10-phenoxazinyl group), oxazolyl group (2-oxazolyl group, 4-oxazolyl group, 5-oxazolyl group, 2-oxadiazolyl group, 5-oxadiazolyl group), furazanyl group (3-furazanyl group), thienyl group (2-thienyl group, 3-thienyl group), methylpyrrole-yl group (2-methylpyrrole-1-yl group, 2-methylpyrrole-3-yl group, 2-methylpyrrole-4-yl group, 2-methylpyrrole-5-yl group, 3-methylpyrrole-1-yl group, 3-methylpyrrole-2-yl group, 3-methylpyrrole-4-yl group, 3-methylpyrrole-5-yl group), butylpyrrole-yl group (2-t-butylpyrrole-4-yl group), 3-(2-phenylpropyl)pyrrole-1-yl group, methyl-indolyl group (2-methyl-1-indolyl group, 4-methyl-1-indolyl group, 2-methyl-3-indolyl group, 4-methyl-3-indolyl group), and butyl-indolyl group (2-t-butyl-1-indolyl group, 4-t-butyl-1-indolyl group, 2-t-butyl-3-indolyl group, 4-t-butyl-3-indolyl group). Preferable examples are pyridyl group and pyrimidyl group.

The silicon-containing compound represented by the general formula (1) of the present invention is preferably a silicon-containing anthracene derivative having a partial structure (A) of either a residue of the following general formula (7) or a residue of the following general formula (8).

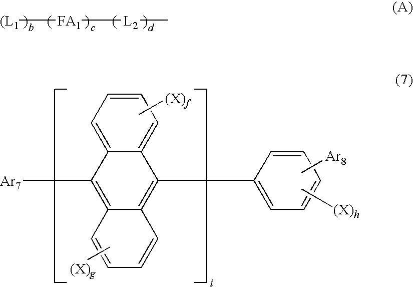

where: X's may be independently identical to or different from each other and X represents a single bond, a hydrogen atom, a substituted or unsubstituted aromatic hydrocarbon group having 6 to 50 ring carbon atoms, a substituted or unsubstituted aromatic heterocyclic group having 5 to 50 ring carbon atoms, a substituted or unsubstituted alkyl group having 1 to 50 carbon atoms, a substituted or unsubstituted cycloalkyl group having 3 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 carbon atoms, a substituted or unsubstituted arylthio group having 5 to 50 carbon atoms, a substituted or unsubstituted alkoxycarbonyl group having 1 to 50 carbon atoms, a substituted or unsubstituted silyl group, a carboxyl group, a halogen atom, a cyano group, a nitro group or a hydroxyl group; Ar₇ and Ar₈ may be independently identical to or different from each other, and each independently represent a substituted or unsubstituted aromatic hydrocarbon group having 6 to 50 ring carbon atoms, or a substituted or unsubstituted fused aromatic group having 8 to 50 ring carbon atoms; and when they each represents the fused aromatic group having 8 to 50 ring carbon atoms, they each corresponds to either a 1-naphthyl group represented by the following general formula (B) or a 2-naphthyl group represented by the following general formula (C);

with the proviso that when a=e=1 in the general formula (1), a case where Ar₇ corresponds to phenylene group is excluded.

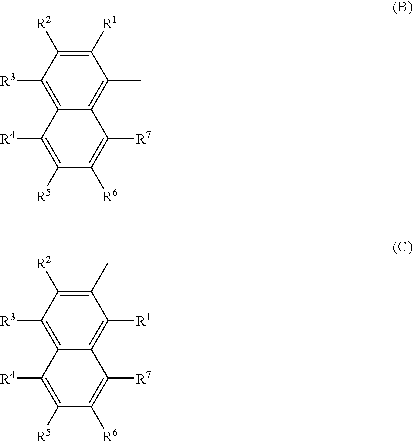

where: R¹ to R⁷ may be independently identical to or different from each other, and each represent a single bond, a hydrogen atom or a substituted or unsubstituted alkyl group having 1 to 50 carbon atoms; f, g, and h each independently represents an integer of 0 to 4; i represents an integer of 1 to 3; with the proviso that when i is an integer of 2 or greater, the plural groups within square brackets ([ ]) may be identical to or different from each other.

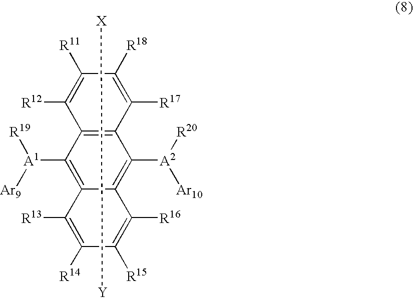

where: A¹ and A² may be independently identical to or different from each other, and each independently represent a substituted or unsubstituted aromatic hydrocarbon group having 6 to 50 ring carbon atoms, or a substituted or unsubstituted fused aromatic group having 8 to 50 ring carbon atoms; Ar₉ and Ar₁₀ may be independently identical to or different from each other, and each independently represent a single bond, a hydrogen atom, a substituted or unsubstituted aromatic hydrocarbon group having 6 to 50 ring carbon atoms, or a substituted or unsubstituted fused aromatic group having 8 to 50 ring carbon atoms; R¹¹ to R²⁰ may be identical to or different from each other, and each independently represent a single bond, a hydrogen atom, a substituted or unsubstituted aromatic hydrocarbon group having 6 to 50 ring carbon atoms, a substituted or unsubstituted aromatic heterocyclic group having 5 to 50 ring atoms, a substituted or unsubstituted alkyl group having 1 to 50 carbon atoms, a substituted or unsubstituted cycloalkyl group having 3 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 carbon atoms, a substituted or unsubstituted arylthio group having 5 to 50 carbon atoms, a substituted or unsubstituted alkoxycarbonyl group having 1 to 50 carbon atoms, a substituted or unsubstituted silyl group, a carboxyl group, a halogen atom, a cyano group, a nitro group and a hydroxyl group;

Ar₉, Ar₁₀, R¹⁹ and R²⁰ may exist in plural numbers respectively; with the proviso that, when a=e=1 in the general formula (1), the groups at 9- and 10-positions of the central anthracene are not symmetrical with respect to the X-Y axis in the general formula (8).

In the case of the silicon-containing compound (1-3) or (1-5) represented by the general formula (1) of the present invention, it is preferable that the partial structure (A) in each above cases is silicon-containing pyrene derivative having structure (9-1) or (9-2) respectively.

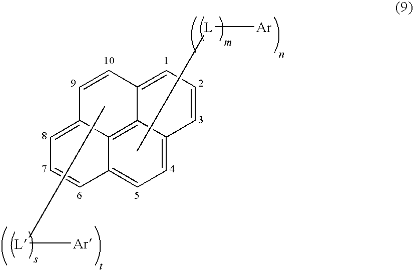

where: L, L′, Ar and Ar′ may be independently identical to or different from each other, and each independently represent a single bond, a hydrogen atom, a substituted or unsubstituted aromatic hydrocarbon group having 6 to 50 ring carbon atoms, a substituted or unsubstituted aromatic heterocyclic group having 5 to 50 ring atoms, a substituted or unsubstituted fused aromatic group having 8 to 50 ring carbon atoms, a substituted or unsubstituted alkyl group having 1 to 50 carbon atoms, a substituted or unsubstituted cycloalkyl group having 3 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 atoms, a substituted or unsubstituted arylthio group having 5 to 50 carbon atoms, a substituted or unsubstituted alkoxycarbonyl group having 1 to 50 carbon atoms, a substituted or unsubstituted silyl group, a carboxyl group, a halogen atom, a cyano group, a nitro group or a hydroxyl group; m and s each independently represent an integer 0 to 2, n and t each independently represents an integer of 0 to 4;

L or Ar is bonded to any one of 1- to 5-positions of pyrene ring; and L′ or Ar′ is bonded to any one of 6- to 10-positions of pyrene ring; and further, (L)ₘ-Ar bonded to any one of 1- to 5-positions of pyrene ring and (L₁)ᵣ-Ar′ bonded to any one of 6- to 10-positions of pyrene ring may be identical to or different from each other.

(9-1) with the proviso that when a=e=1 in the general formula (1), a case where both (L)ₘ-Ar and (L′)ₛ-Ar′ in the general formula (9) are simultaneously phenylene groups is excluded.

(9-2) with the proviso that when a=e=1 in the general formula (1), both (L)ₘ-Ar and (L′)ₛ-Ar′ in the general formula (9) are simultaneously phenylene groups.

Examples of the substituent of each group in the general formulae (1) to (9) include alkyl group (methyl group, ethyl group, propyl group, isopropyl group, n-butyl group, s-butyl group, isobutyl group, t-butyl group, n-pentyl group, n-hexyl group, n-heptyl group, n-octyl group, hydroxymethyl group, 1-hydroxyethyl group, 2-hydroxyethyl group, 2-hydroxy isobutyl group, 1,2-dihydroxy ethyl group, 1,3-dihydroxy isopropyl group, 2,3-dihydroxy-t-butyl group, 1,2,3-trihydroxy propyl group, chloromethyl group, 1-chloroethyl group, 2-chloroethyl group, 2-chloroisobutyl group, 1,2-dichloroethyl group, 1,3-dichloro isopropyl group, 2,3-dichloro-t-butyl group, 1,2,3-trichloropropyl group, bromomethyl group, 1-bromoethyl group, 2-bromoethyl group, 2-bromo isobutyl group, 1,2-dibromo ethyl group, 1,3-dibromo isopropyl group, 2,3-dibromo-t-butyl group, 1,2,3-tribromopropyl group, iodomethyl group, 1-iodo ethyl group, 2-iodo ethyl group, 2-iodo isobutyl group, 1,2-diiodo ethyl group, 1,3-diiodo isopropyl group, 2,3-diiodo-t-butyl group, 1,2,3-triiodopropyl group, aminomethyl group, 1-amino ethyl group, 2-amino ethyl group, 2-amino isobutyl group, 1,2-diamino ethyl group, 1,3-diamino isopropyl group, 2,3-diamino-t-butyl group, 1,2,3-triaminopropyl group, cyanomethyl group, 1-cyanoethyl group, 2-cyanoethyl group, 2-cyano isobutyl group, 1,2-dicyano ethyl group, 1,3-dicyano isopropyl group, 2,3-dicyano-t-butyl group, 1,2,3-tricyanopropyl group, nitromethyl group, 1-nitroethyl group, 2-nitroethyl group, 2-nitro isobutyl group, 1,2-dinitro ethyl group, 1,3-dinitro isopropyl group, 2,3-dinitro-t-butyl group, 1,2,3-trinitropropyl group, cyclopropyl group, cyclobutyl group, cyclopentyl group, cyclohexyl group, 4-methylcyclohexyl group, 1-adamantyl group, 2-adamantyl group, 1-norbornyl group, 2-norbornyl group), alkoxy group having 1 to 6 carbon atoms (ethoxy group, methoxy group, i-propoxy group, n-propoxy group, s-butoxy group, t-butoxy group, pentoxy group, hexyloxy group, cyclopentoxy group, cyclohexyloxy group), aryl group having 5 to 40 ring atoms, amino group substituted with aryl group having 5 to 40 ring atoms, ester group with aryl group having 5 to 40 ring atoms, ester group with alkyl group having 1 to 6 carbon atoms, cyano group, nitro group, halogen atom, triarylsilyl group, trialkylsilyl group, arylalkylsilyl group, and pyridyl group.

Specific examples of the silicon-containing compound represented by the general formulae (1) to (6) of the present invention are shown below, though not particularly limited thereto.

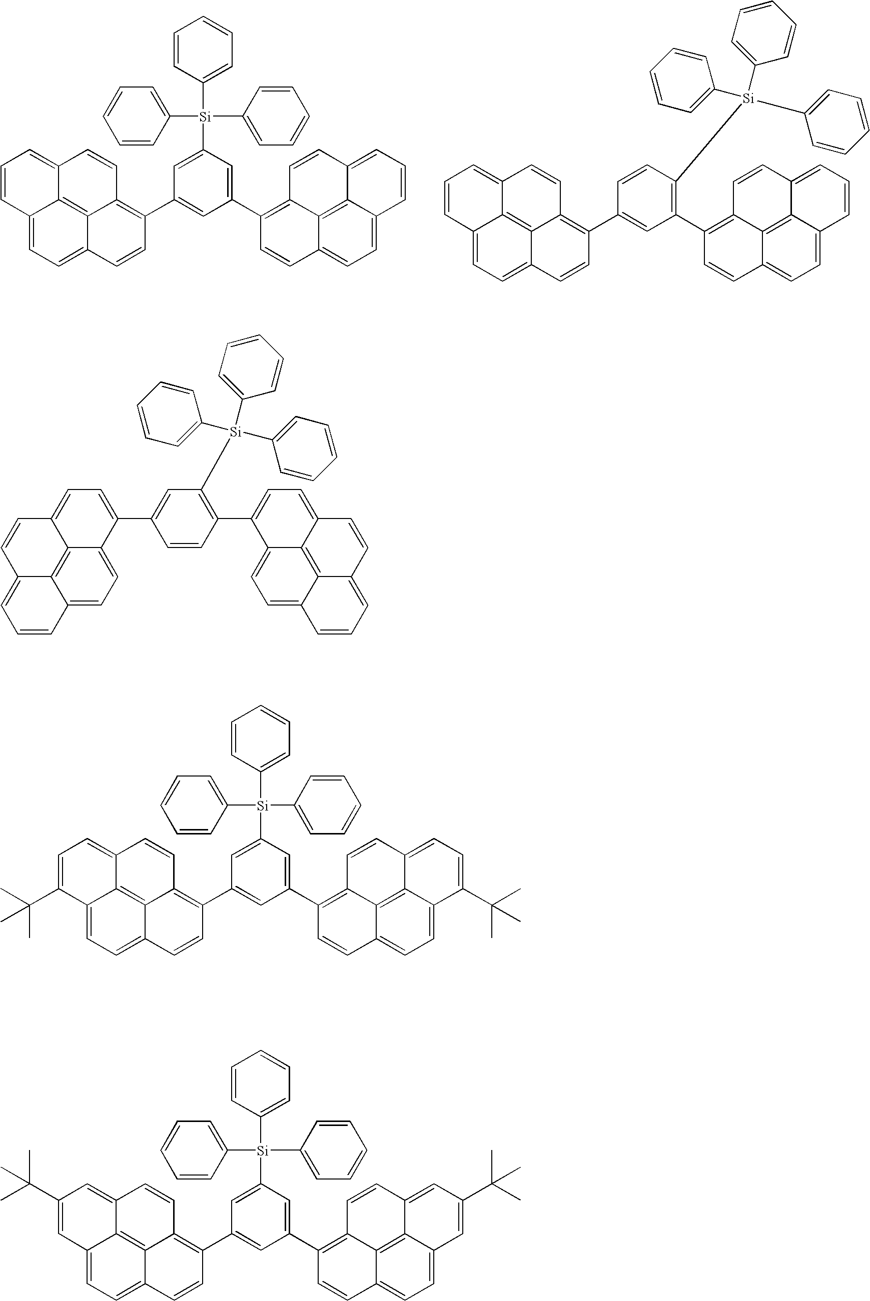

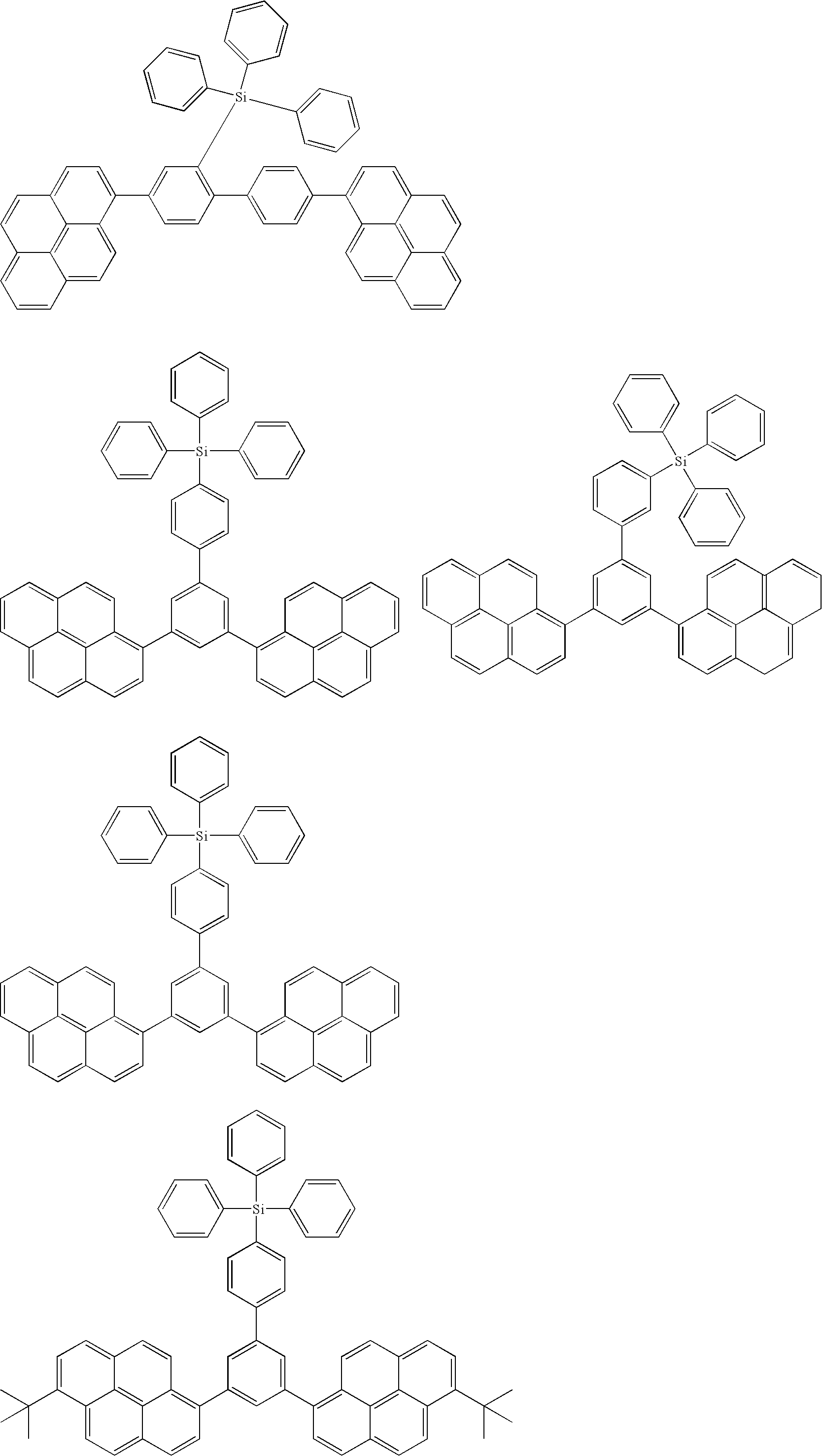

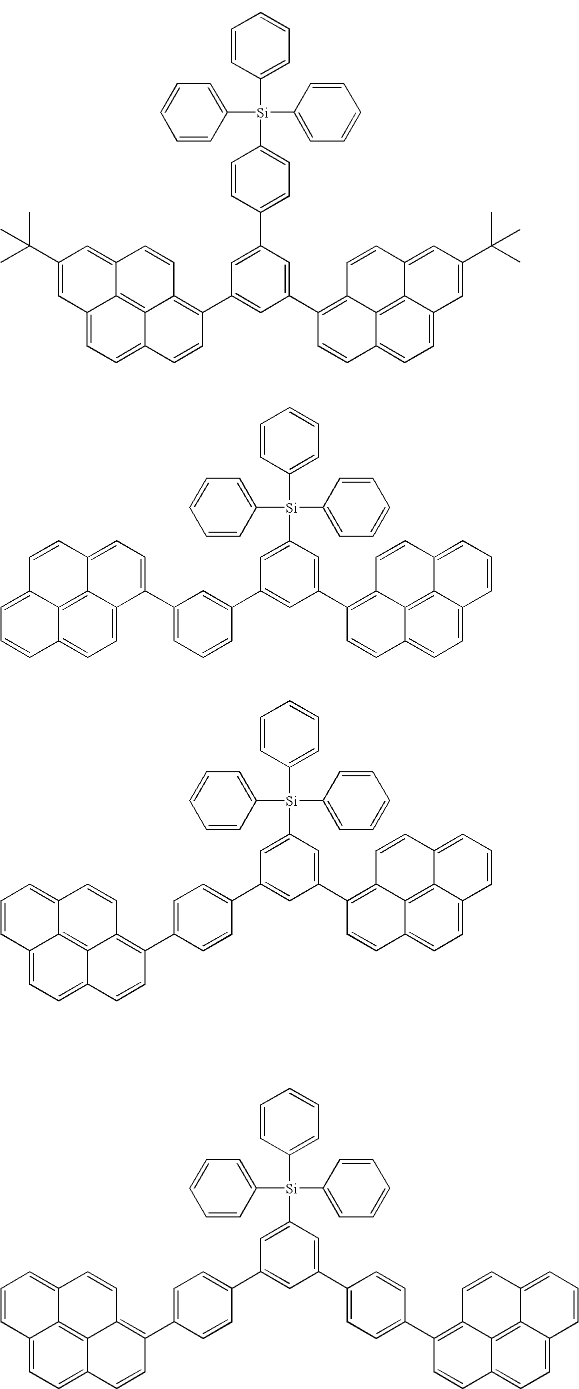

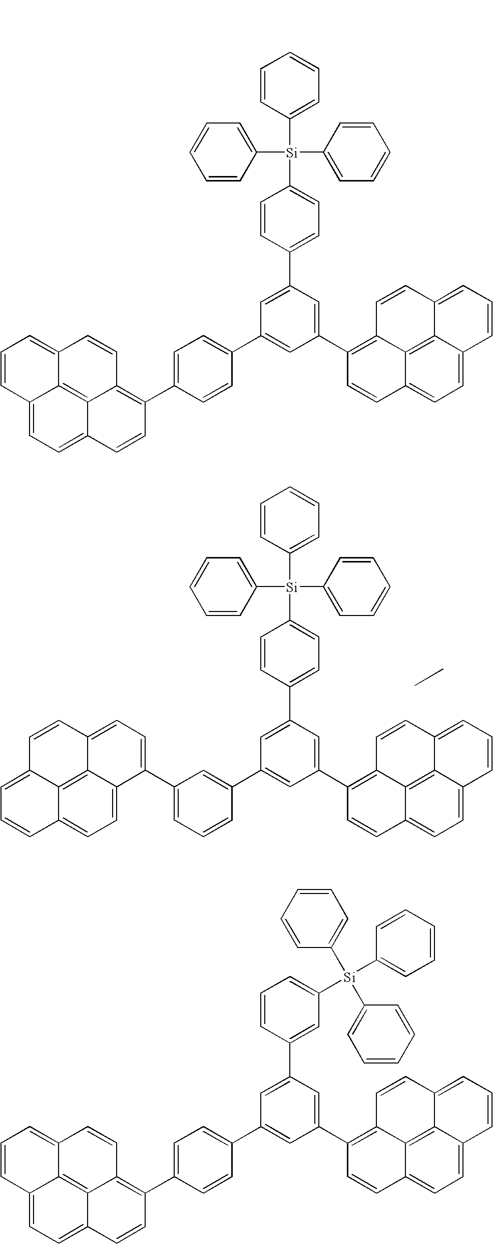

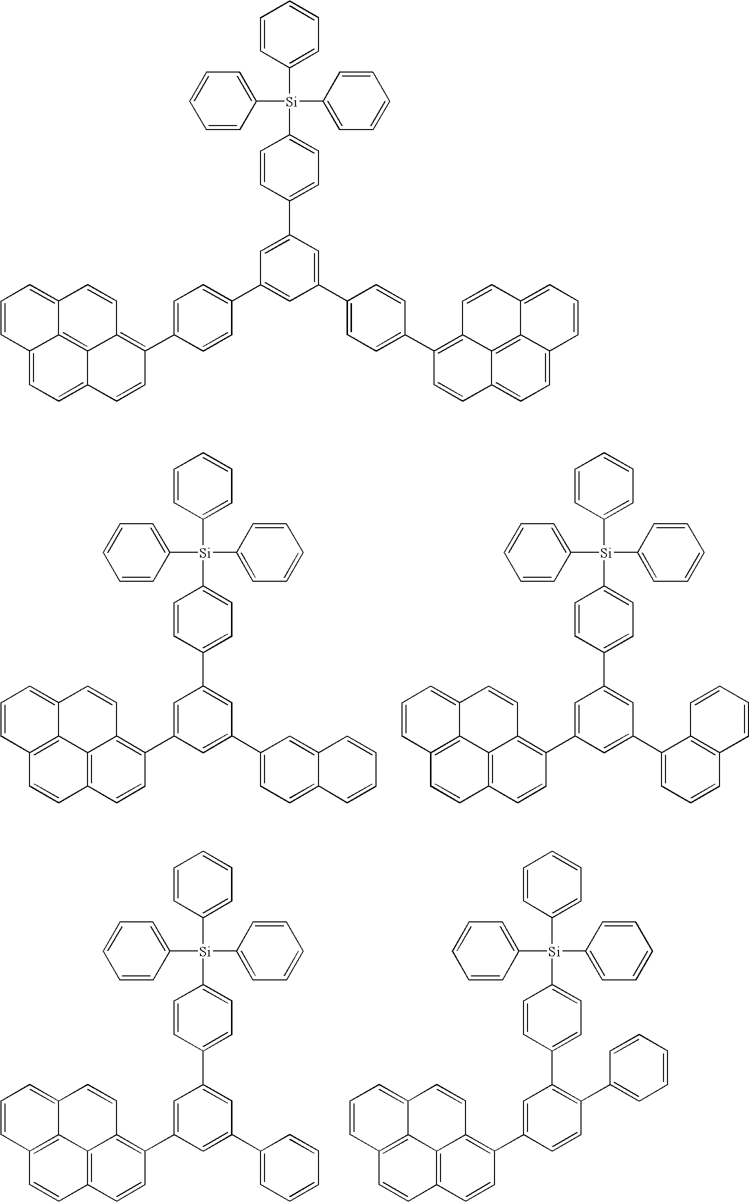

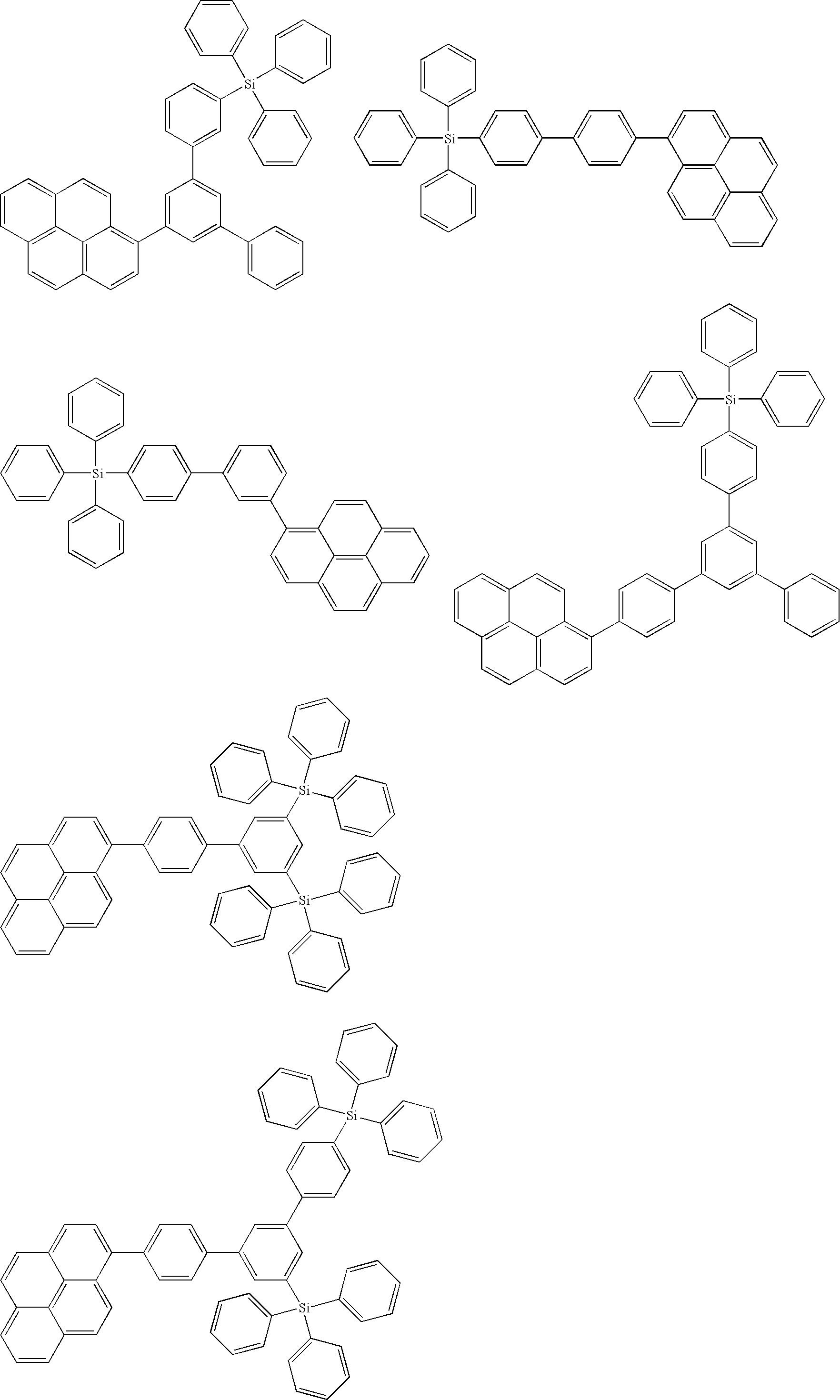

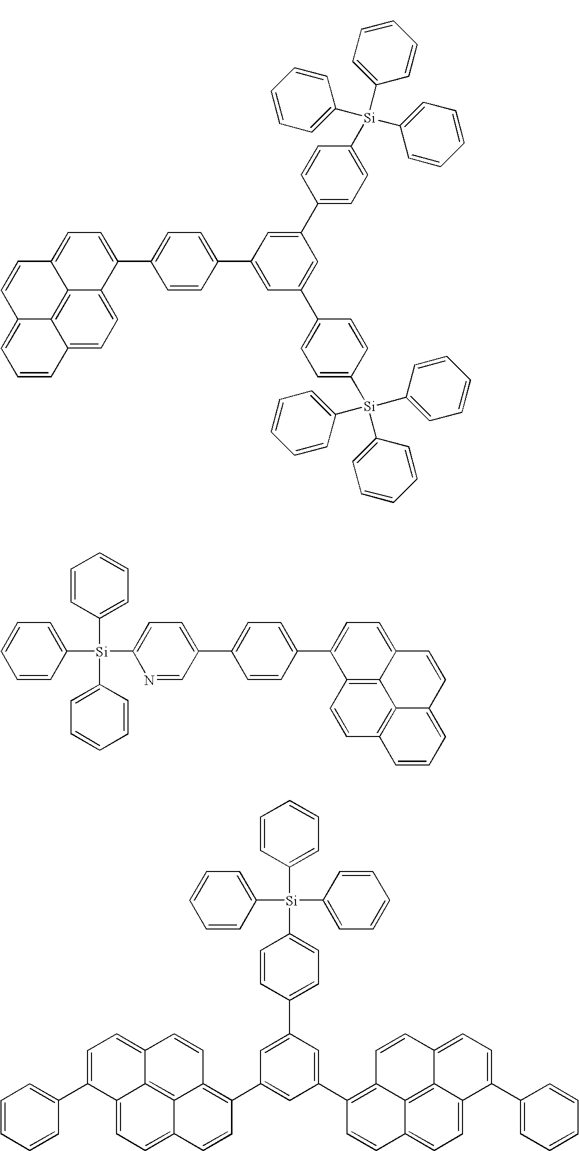

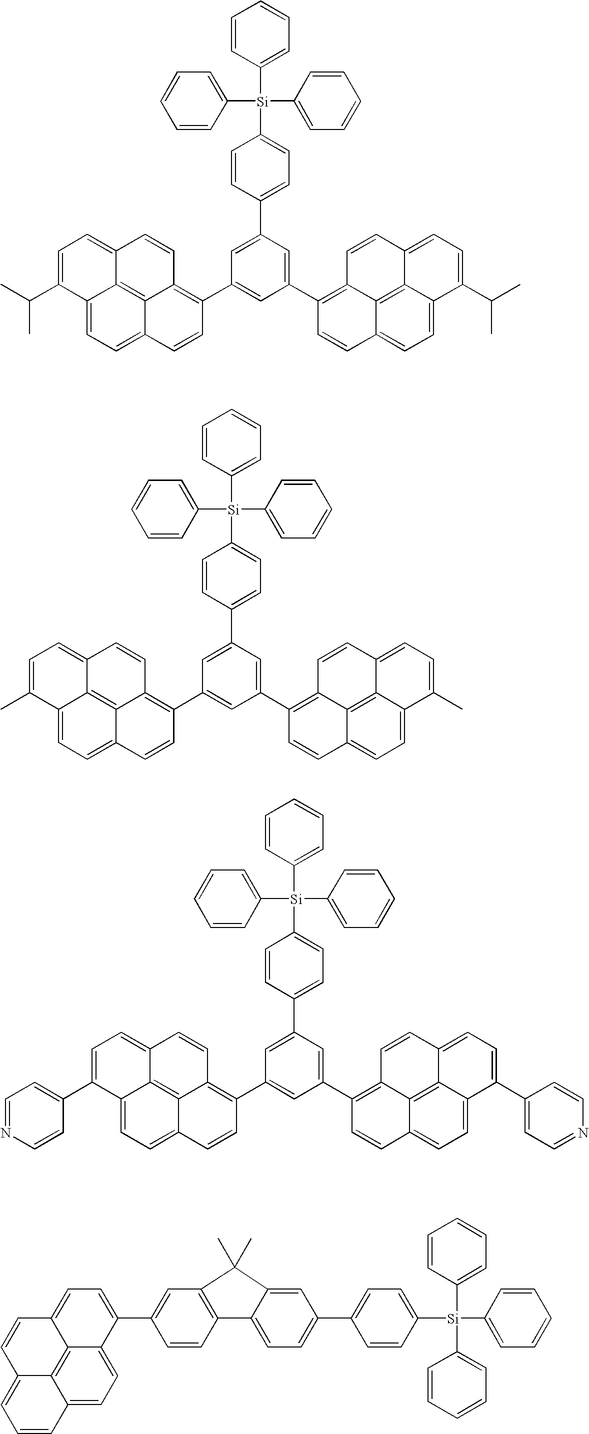

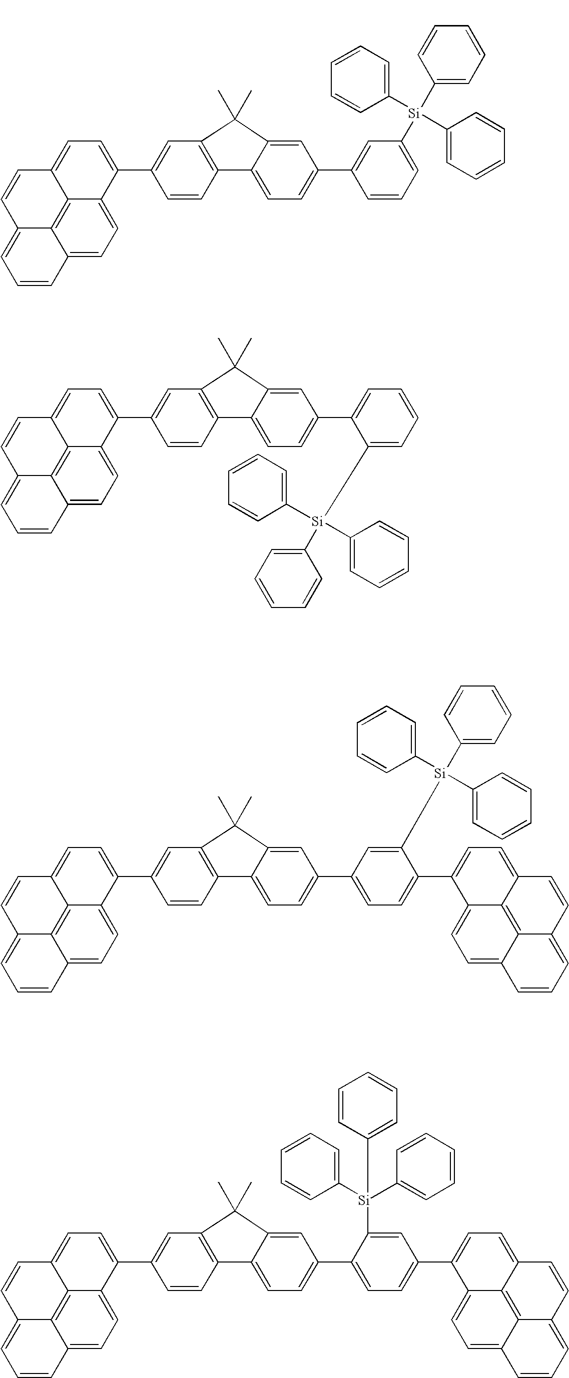

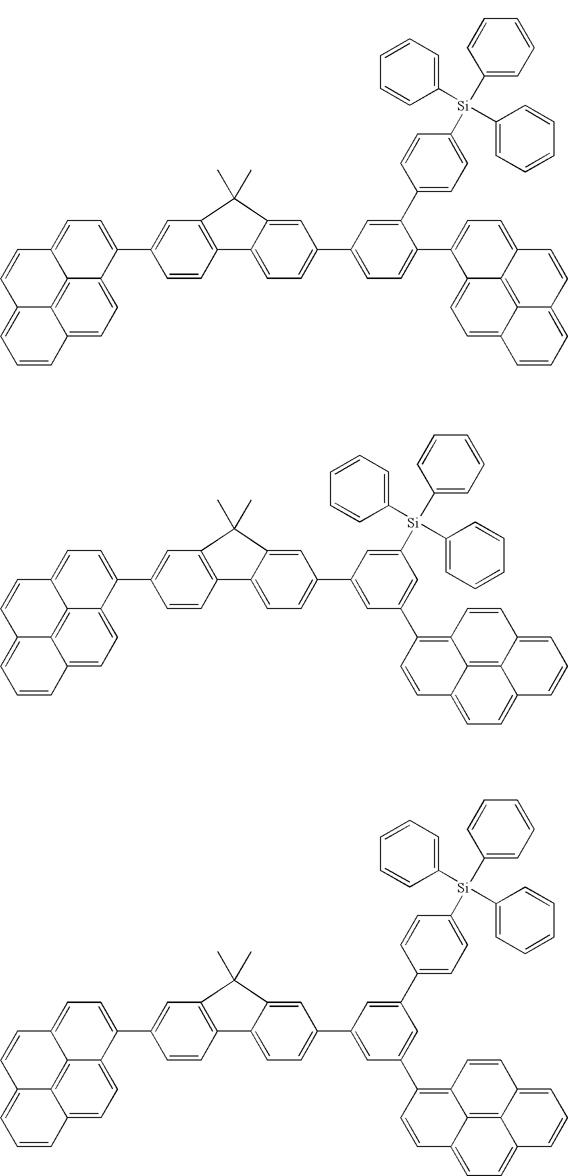

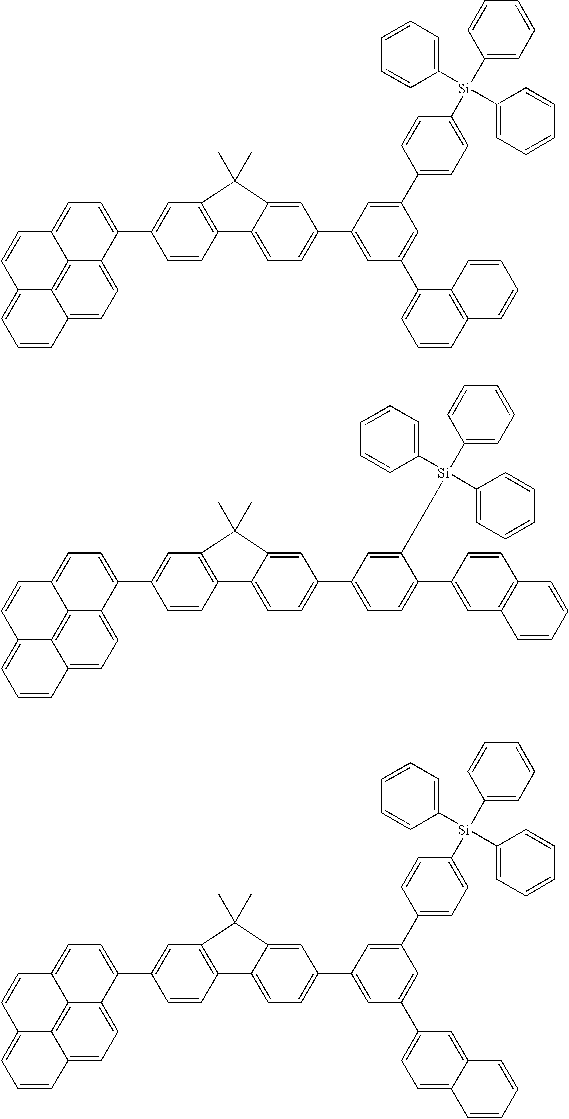

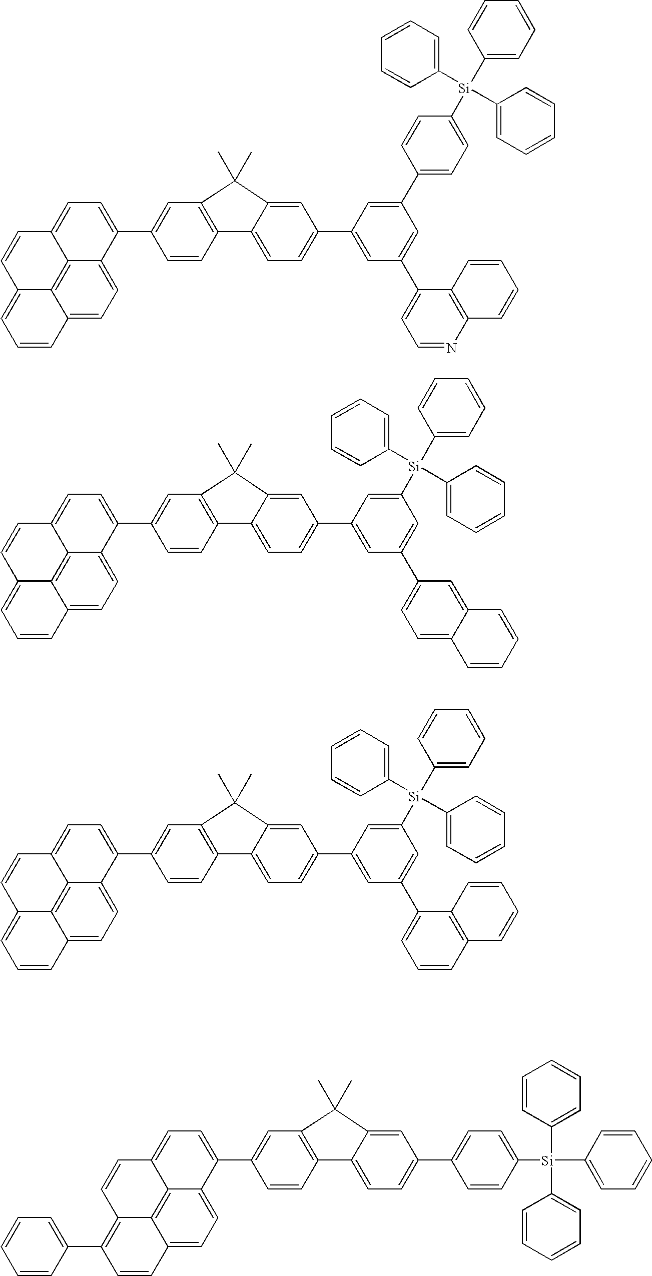

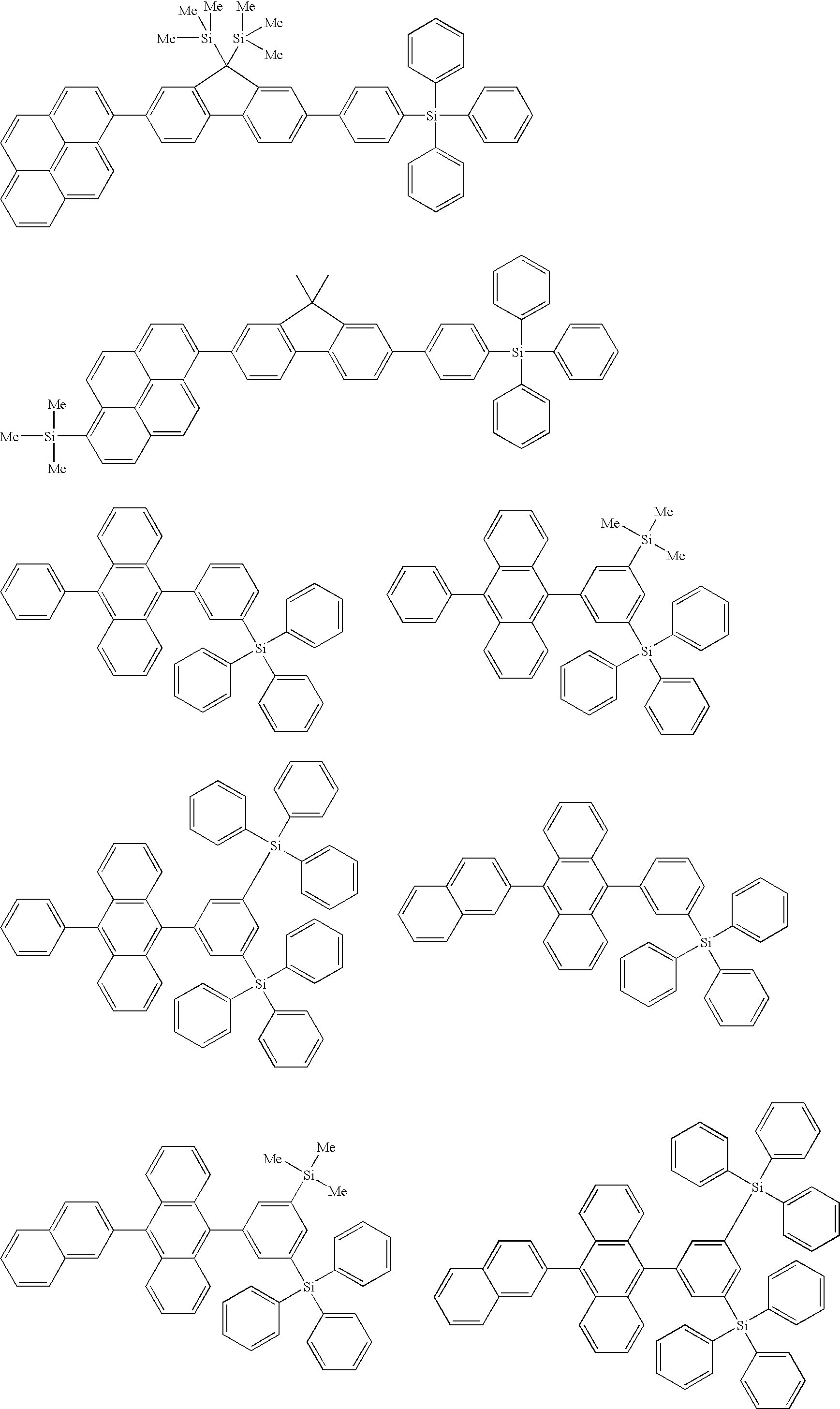

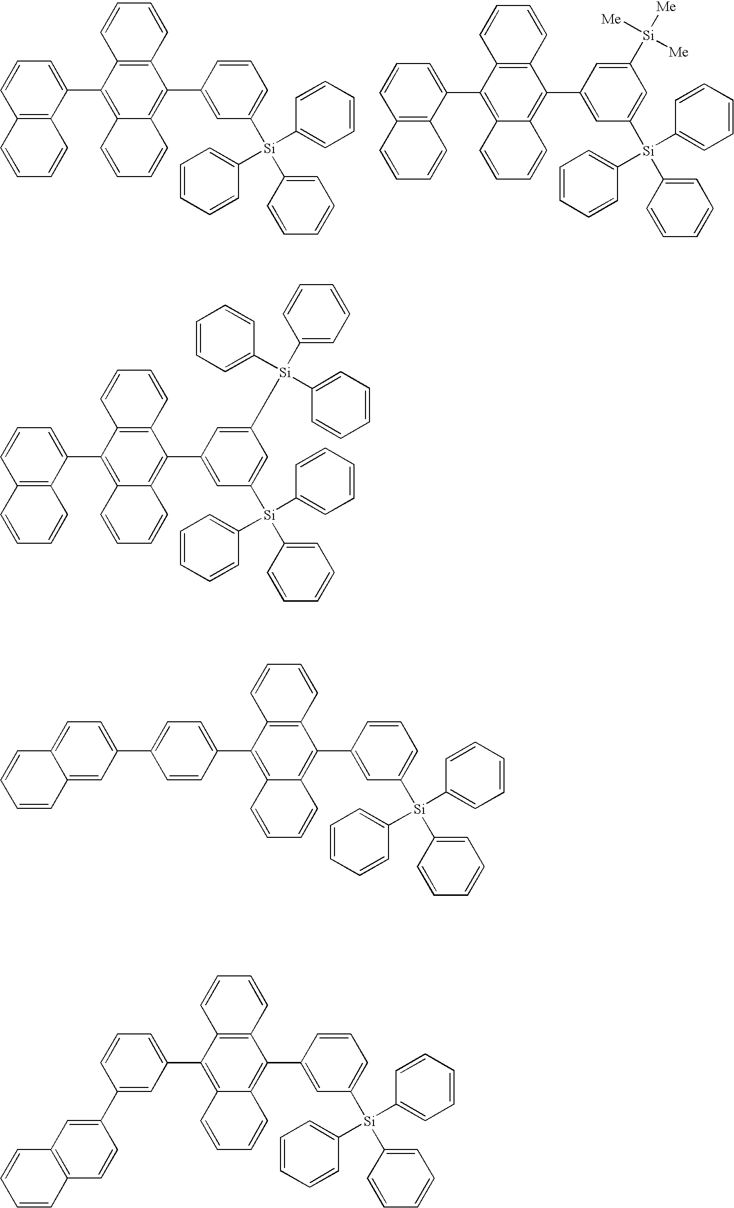

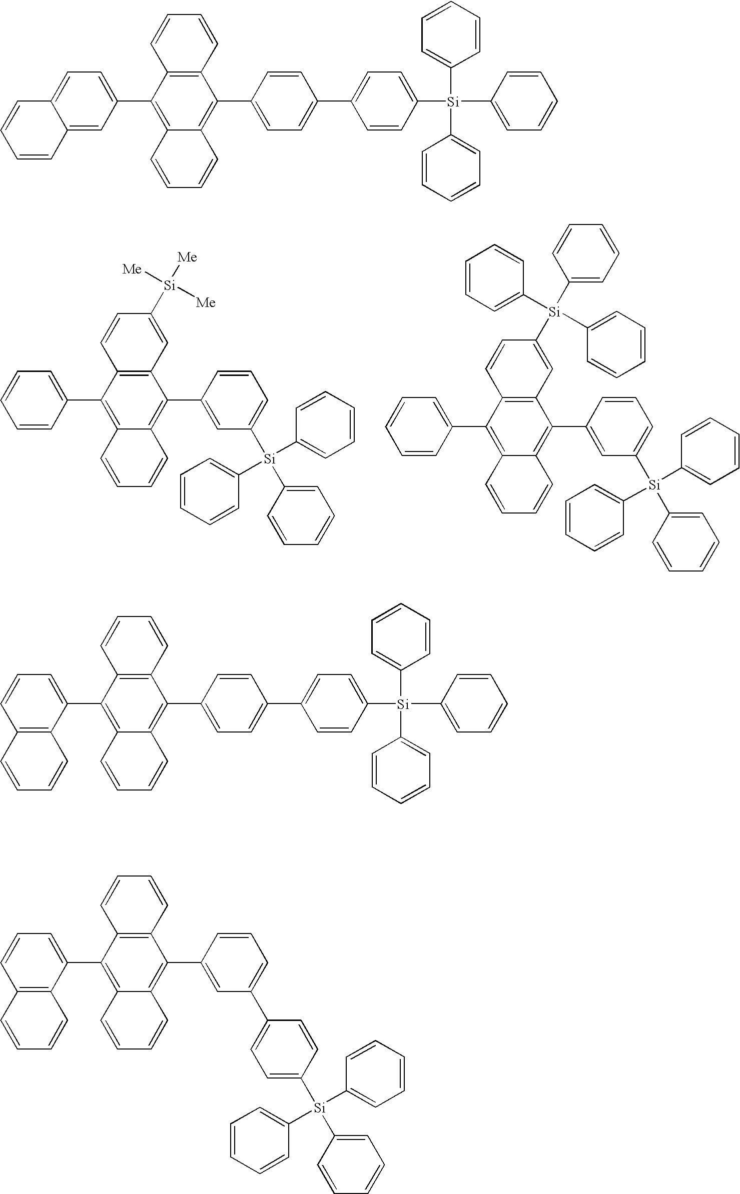

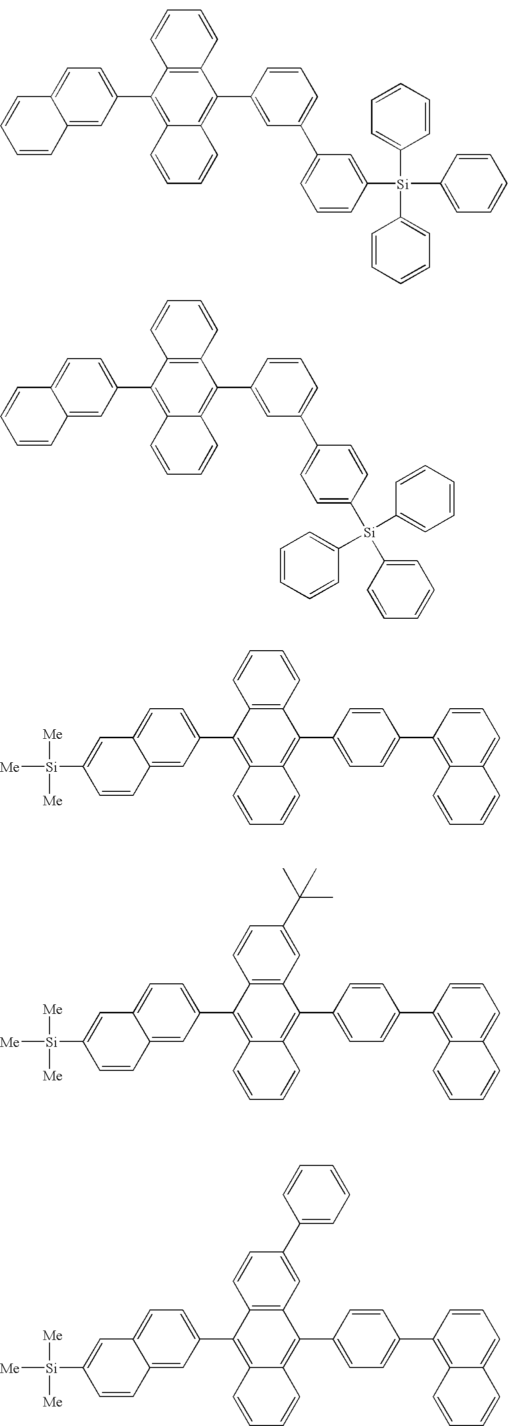

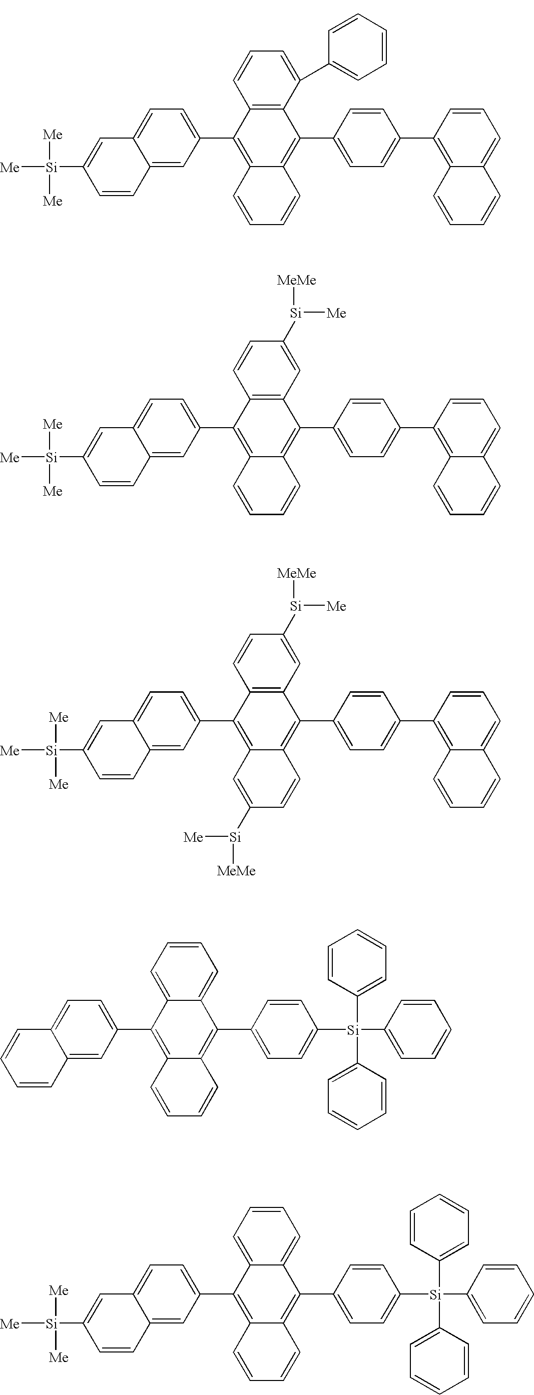

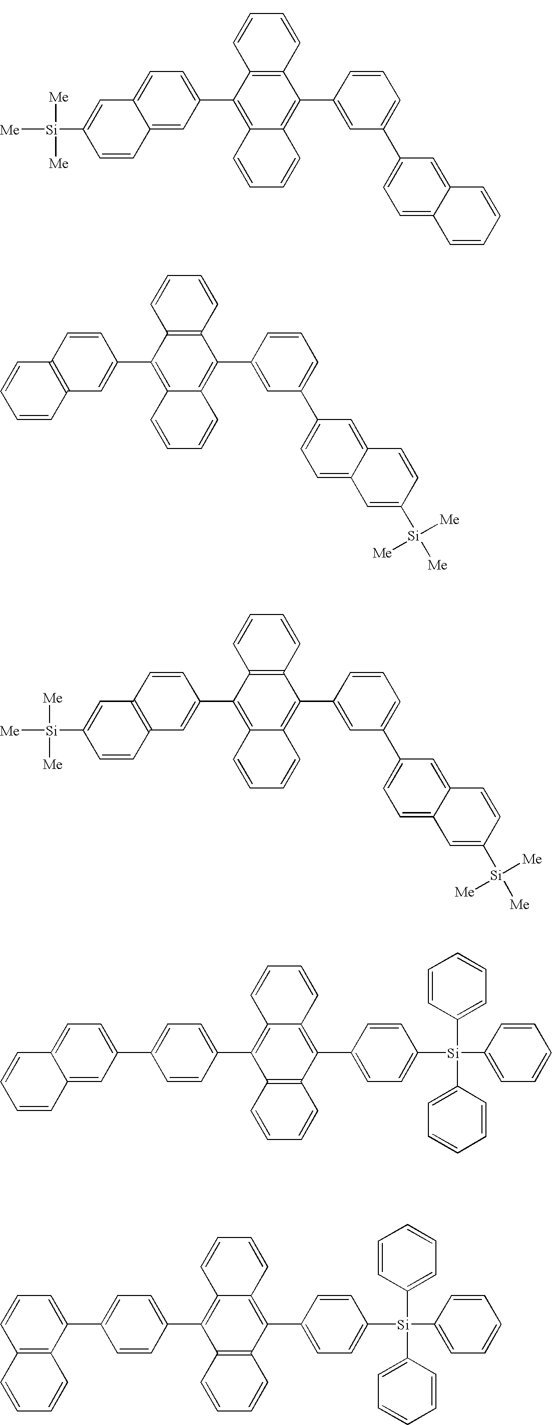

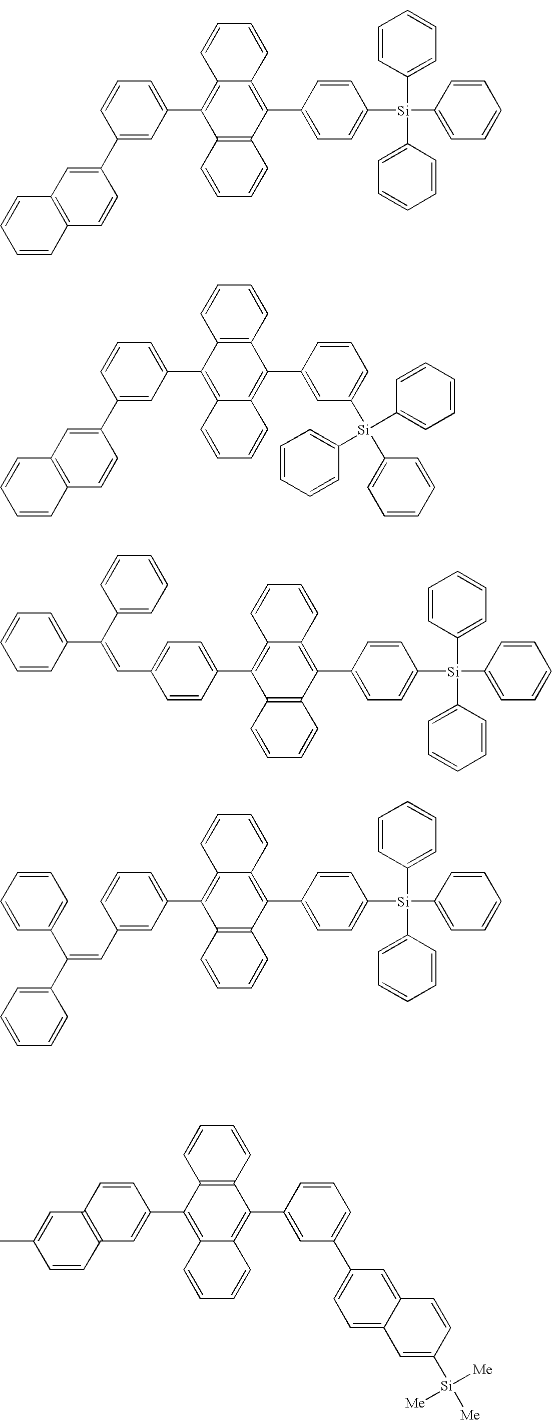

Following is a description about the organic EL device of the present invention.

The present invention provides an organic EL device which is composed of one or more organic thin film layers including at least one light emitting layer and interposed between a cathode and an anode, wherein at least one of the organic thin film layers includes the silicon-containing compound, the silicon-containing anthracene derivative or the silicon-containing aromatic pyrene derivative alone or as a component of a mixture.

The silicon-containing compound, the silicon-containing anthracene derivative or the silicon containing pyrene derivative of the present invention may be suitably included in any one of the above-mentioned organic thin film layers. It is particularly preferable that any one of the compounds is used in a light emitting region, and it is further preferable that any one of the compounds is used in a light emitting layer because a superior organic EL device can be provided.

Additionally, the term “silicon-containing compound” includes silicon-containing anthracene derivatives or silicon-containing pyrene derivatives in the present invention.

In the organic EL device of the present invention, the light emitting layer preferably includes the silicon-containing compound as the light emitting material. It is preferable that the light emitting layer includes the silicon-containing compound as a host material, at a content of preferably 10 to 100% by weight, or more preferably 50 to 99% by weight.

Moreover, the light emitting layer preferably further includes a fluorescent dopant or a phosphorescent dopant.

The fluorescent dopant is preferably a compound selected from, for example, an amine-based compound, an aromatic compound, a chelate complex such as a tris(8-quinolinolato)aluminum complex, a coumarin derivative, a tetraphenylbutadiene derivative, a bisstyrylarylene derivative, and an oxadiazole derivative in accordance with a requested luminescent color. In particular, preferable examples include an arylamine compound, an aryldiamine compound. Among those, a styryl amine compound, a styryl diamine compound, an aromatic amine compound, an aromatic diamine compound, and a fused polycyclic aromatic compound (excluding an amine compound) are further preferable. Those fluorescent dopants may be usable alone or as a component of a mixture.

Preferred styryl amine compounds and styryl diamine compounds are represented by the following general formula (a):

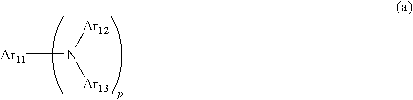

where: Ar₁₁ represents a group selected from a phenyl group; a biphenyl group, a terphenyl group, a stilbene group, and a distyrylaryl group; Ar₁₂ and Ar₁₃ each represent a hydrogen atom or an aromatic hydrocarbon group having 6 to 20 carbon atoms; each of Ar₁₁, Ar₁₂, and Ar₁₃ may be substituted; p represents an integer of 1 to 4, and preferably an integer of 1 or 2; and at least one of Ar₁₂ and Ar₁₃ is more preferably substituted by the styryl groups.

Examples of the aromatic hydrocarbon group having 6 to 20 carbon atoms include a phenyl group, a naphthyl group, an anthranyl group, a phenanthryl group, a terphenyl group, etc.

Preferred aromatic amine compounds and aromatic diamine compounds are represented by the following general formula (b):

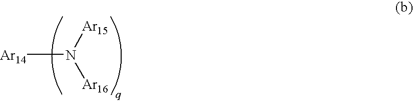

where: Ar₁₄ to Ar₁₆ each represent a substituted or unsubstituted aryl group having 5 to 40 ring carbon atoms; q represents an integer of 1 to 4, and preferably an integer of 1 or 2.

Here, preferable examples of the aryl group having 5 to 40 ring carbon atoms include a phenyl group, a naphthyl group, an anthranyl group, a phenanthryl group, a pyrenyl group, a coronyl group, a biphenyl group, a terphenyl group, a pyrrolyl group, a furanyl group, a thiophenyl group, a benzothiophenyl group, an oxadiazolyl group, a diphenylanthranyl group, an indolyl group, a carbazolyl group, a pyridyl group, a benzoquinolyl group, a fluoranthenyl group, an acenaphthofluoranthenyl group, a stilbene group, a perylenyl group, a chrysenyl group, a pycenyl group, a triphenylenyl group, a rubicenyl group, a benzoanthracenyl group, a phenylanthracenyl group, a bisanthracenyl group, and aryl groups represented by the following general formulae (c) and (d), where a napthyl group, an anthranyl group, a chrysenyl group, a pyrenyl group, and an aryl group represented by the following general formula (d) are preferable.

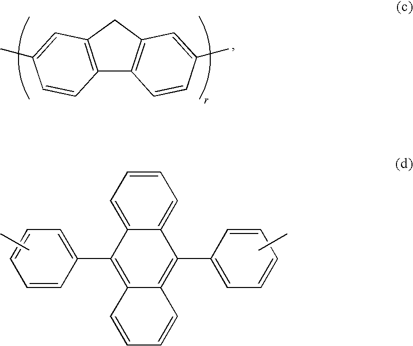

In the general formula (c), r represents an integer of 1 to 3.

It should be noted that a preferable substituent for the aryl group is, for example, an alkyl group having 1 to 6 carbon atoms (such as an ethyl group, a methyl group, an isopropyl group, an n-propyl group, an s-butyl group, a t-butyl group, a pentyl group, a hexyl group, a cyclopentyl group, or a cyclohexyl group), an alkoxy group having 1 to 6 carbon atoms (such as an ethoxy group, a methoxy group, an isopropoxy group, an n-propoxy group, an s-butoxy group, a t-butoxy group, a pentoxy group, a hexyloxy group, a cyclopentoxy group, or a cyclohexyloxy group), an aryl group having 5 to 40 ring carbon atoms, an amino group substituted by an aryl group having 5 to 40 ring carbon atoms, an ester group having an aryl group having 5 to 40 ring carbon atoms, an ester group having an alkyl group having 1 to 6 carbon atoms, a cyano group, a nitro group, or a halogen atom.

The fused polycyclic aromatic compounds such as naphthalene, anthracene, phenanthrene, pyrene, coronene, biphenyl, terphenyl, pyrrole, furan, thiophene, benzothiophene, oxadiazole, indole, carbazole, pyridine, benzoquinoline, fluoranthenine, benzofluoranthene, acenaphthofluoranthenine, stilbene, perylene, chrysene, picene, triphenylenine, rubicene, and benzanthracene and those derivatives are preferable as the fused polycyclic aromatic compound (excluding amine compounds).

The phosphorescent dopant is preferably a metal complex containing at least one metal selected from the group consisting of Ir, Ru, Pd, Pt, Os, and Re. The ligand of the metal complex preferably includes at least one skeleton selected from the group consisting of phenylpyridine skeleton, bipyridyl skeleton, and phenanthroline skeleton. Specific examples of the metal complex include tris(2-phenylpyridine)iridium, tris(2-phenylpyridine)ruthenium, tris(2-phenylpyridine)palladium, bis(2-phenylpyridine)platinum, tris(2-phenylpyridine)osmium, tris(2-phenylpyridine)rhenium, octaethyl platinum porphyrin, octaphenyl platinum porphyrin, octaethyl palladium porphyrin, and octaphenyl palladium porphyrin. However, the metal complex is not limited thereto, and the appropriate complex is preferably selected in terms of a desired luminescent color, a device performance, and a relationship with a host compound.

Following is a description regarding a device structure about the organic EL device of the present invention.

The organic EL device of the present invention is a device obtained by forming an organic thin film layer formed of one or more layers between an anode and a cathode. In the case where the organic thin film layer is formed of one layer, a light emitting layer is provided between the anode and the cathode. The light emitting layer contains a light emitting material, and may contain a hole injecting material or an electron injecting material in addition to the light emitting material for transporting, to the light emitting material, a hole injected from the anode or an electron injected from the cathode. The light emitting material preferably forms a uniform thin film bringing together extremely high fluorescent quantum efficiency, a high hole transporting ability, and a high electron transporting ability.

When the film of organic compounds in the organic EL device has a plurality of layers, the organic EL device has a laminate structure of a plurality of layers such as (an anode/a hole injecting layer/a light emitting layer/a cathode), (an anode/a light emitting layer/an electron injecting layer/a cathode) and (an anode/a hole injecting layer/a light emitting layer/an electron injecting layer/a cathode).

In addition to the light emitting layer shown in the general formulae (1) to (6) of the present invention, an additional known light emitting material, doping material, hole injecting material, or electron-injecting material can be used as required in the light emitting layer. As the doping material, in addition to conventional fluorescent light emitting materials, any one of a heavy metal complex such as phosphorescent emission iridium may be used. By forming the organic EL device in a multi-layer structure, decreases in the luminance and the life due to quenching can be prevented. If needed, a light emitting material, another doping material, a hole injecting material, and an electron-injecting material can be used in combination. By using other doping materials, the luminance and the efficiency of the light emission can be improved and red light or white light can be emitted. Further, in the organic EL device of the present invention, the hole injecting layer, the light emitting layer and the electron injecting layer may respectively have a laminated structure including two or more layers. In this case, the multi-layer hole injecting layer may be constituted from a hole injecting layer into which holes are injected from the electrode, and a hole transporting layer for accepting the holes from the hole injecting layer and transporting the holes to the light emitting layer. Also, the multi-layer electron injecting layer may be constituted from an electron injecting layer into which electrons are injected from the electrode, and an electron transporting layer for accepting the electrons from the electron injecting layer and transporting the electrons to the light emitting layer. Each of those layers is selected and used depending on factors such as the energy level of a material, heat resistance, and adhesiveness between the layer and an organic layer or a metal electrode.

Examples of a light emitting material or a host material which can be used in the organic layer together with the compounds of the general formula (1) to (6) include, but are not limited to, anthracene, naphthalene, phenanthrene, pyrene, tetracene, coronene, chrysene, fluoresceine, perylene, phthaloperylene, naphthaloperylene, perynone, phthaloperynone, naphthaloperynone, diphenylbutadiene, tetraphenylbutadiene, coumarin, oxadiazole, aldazine, bisbenzoxazoline, bisstyryl, pyrazine, cyclopentadiene, quinoline metal complexes, aminoquinoline metal complexes, benzoquinoline metal complexes, imine, diphenylethylene, vinylanthracene, diaminocarbazole, pyrane, thiopyrane, polymethine, merocyanine, imidazole-chelated oxynoid compounds, quinacridone, rubrene, a stilbene-based derivative, and fluorescent dyes.

A compound having an ability of transporting a hole, having hole injecting effect from an anode and excellent hole injecting effect to a light emitting layer or a light emitting material, an ability of preventing the migration of an exciton generated in the light emitting layer to an electron injecting layer or an electron injecting material, and having excellent thin film-formability is preferable as a hole injecting and transporting material. Specific examples of the compound include, but are not limited to, a phthalocyanine derivative, a naphthalocyanine derivative, a porphyrin derivative, oxazole, oxadiazole, triazole, imidazole, imidazolone, imidazolethione, pyrazoline, pyrazolone, tetrahydroimidazole, oxazole, oxadiazole, hydrazone, acylhydrazone, polyarylalkane, stilbene, butadiene, benzidine type triphenylamine, styrylamine type triphenylamine, diamine type triphenylamine, derivatives thereof, and polymer materials such as polyvinyl carbazole, polysilane, and a conductive polymer.

Of the hole injecting and transporting materials that can be used in the organic EL device of the present invention, additional effective hole injecting materials are an aromatic tertiary amine derivative or a phthalocyanine derivative.

Specific examples of the aromatic tertiary amine derivative include, but are not limited to, triphenylamine, tritolylamine, tolyldiphenylamine, N,N′-diphenyl-N,N′-(3-methylphenyl) 1,1′-biphenyl-4,4′-diamine, N,N,N′,N′-(4-methylphenyl)-1,1′phenyl-4,4′-diamine, N,N,N′,N′-(4-methylphenyl)-1,1′-biphenyl-4,4′-diamine, N,N′-diphenyl-N,N′-dinaphthyl-1,1′-biphenyl-4,4′-diamine, N,N′-(methylphenyl)-N,N′-(4-n-butylphenyl)phenanthrene-9,10-diamine, N,N-bis(4-di-4-tolylaminophenyl)-4-phenyl-cyclohexane, or an oligomer or a polymer having those aromatic tertiary amine skeletons.

Specific examples of the phthalocyanine (Pc) derivative include, but are not limited to, phthalocyanine derivatives such as H₂Pc, CuPc, CoPc, NiPc, ZnPc, PdPc, FePc, MnPc, ClAlPc, ClGaPc, ClInPc, ClSnPc, Cl₂SiPc, (HO)AlPc, (HO)GaPc, VOPc, TiOPc, MoOPc, and GaPc-O-GaPc, and naphthalocyanine derivatives.

A compound having an ability of transporting electrons, having electron injecting effect from a cathode and excellent electron injecting effect to a light emitting layer or a light emitting material, an ability of preventing the migration of an exciton generated in the light emitting layer to the hole injecting layer, and having excellent thin film-formability is preferable as an electron injecting and transporting material. Specific examples of the compound include fluorenone, anthraquinodimethane, diphenoquinone, thiopyranedioxide, oxazole, oxadiazole, triazole, imidazole, perylenetetracarboxylic acid, fluorenylidenemethane, anthraquinodimethane, anthrone, and derivatives thereof, but the compound is not limited thereto. In addition, an electron-accepting substance can be added to the hole injecting material or an electron-donating substance can be added to the electron injecting material to thereby improve properties of charge injection.

An additionally effective electron injecting material in the organic EL device of the present invention is a metal complex compound or a nitrogen-containing five-membered ring derivative.

Examples of the metal complex compound include (8-quinolinato)lithium, bis(8-quinolinato)zinc, bis(8-quinolinato)copper, bis(8-quinolinato)manganese, tris(8-quinolinato)aluminum, tris(2-methyl-8-quinolinato)aluminum, tris(8-quinolinato) gallium, bis(10-hydroxybenzo[h]-quinolinato)beryllium, bis(10-hydroxybenzo[h] quinolinato)zinc, bis(2-methyl-8-quinolinato)chlorogallium, bis(2-methyl-8-quinolinato)(o-cresolato)gallium, bis(2-methyl-8-quinolinato)(1-naphtholato)aluminum and bis(2-methyl-8-quinolinato)(2-naphtholato)gallium. However, the metal complex compound is not limited to the compounds described above as the examples.

Further, preferred nitrogen-containing five-membered derivatives include, an oxazole derivative, a thiazole derivative, an oxadiazole derivative, a thiadiazole derivative, and a triazole derivative. Specific examples of the derivative include, but are not limited to, 2,5-bis(1-phenyl)-1,3,4-oxazole, dimethylPOPOP, 2,5-bis(1-phenyl)-1,3,4-thiazole, 2,5-bis(1-phenyl)-1,3,4-oxadiazole, 2-(4′-t-butylphenyl)-5-(4″-biphenyl)-1,3,4-oxadiazole, 2,5-bis(1-naphthyl)-1,3,4-oxadiazole, 1,4-bis[2-(5-phenyloxadiazolyl)]benzene, 1,4-bis[2-(5-phenyloxadiazolyl)-4-t-butylbenzene], 2-(4′-tertbutylphenyl)-5-(4″-biphenyl)-1,3,4-thiadiazole, 2,5-bis(1-naphthyl)-1,3,4-thiadiazole, 1,4-bis[2-(5-phenylthiadiazolyl)]benzene, 2-(4′-t-butylphenyl)-5-(4″-biphenyl)-1,3,4-triazole, 2,5-bis(1-naphthyl)-1,3,4-triazole, and 1,4-bis[2-(5-phenyltriazolyl)]benzene.

In the organic EL device of the present invention, in addition to the light emitting layer of the general formulae (1) to (6), at least one kind of a light emitting material, a doping material, a hole injecting material, and an electron injecting material may be incorporated into the same organic layer. In addition, the surface of the organic EL device obtained according to the present invention can be provided with a protective layer, or the entire device can be protected with silicone oil, a resin, or the like with a view to improving the stability of the device against temperature, humidity, an atmosphere, or the like.

An electrically conductive material having a work function larger than 4 eV is suitably used in the anode of the organic EL device. Examples of an available electrically conductive material include: carbon, aluminum, vanadium, iron, cobalt, nickel, tungsten, silver, gold, platinum, and palladium, and alloys thereof; metal oxides such as tin oxide and indium oxide to be used in an ITO substrate and an NESA substrate; and organic conductive resins such as polythiophene and polypyrrole.

In the organic EL device of the present invention, an electrically conductive substance having a work function smaller than 4 eV is suitably used in the cathode of the device. Examples of an available electrically conductive substance include, but are not limited to, magnesium, calcium, tin, lead, titanium, yttrium, lithium, ruthenium, manganese, and aluminum, and alloys thereof. Representative examples of the alloys include, but are not limited to, a magnesium/silver alloy, a magnesium/indium alloy, and a lithium/aluminum alloy. A composition ratio of an alloy is controlled depending on, for example, the temperature of a vapor deposition source, an atmosphere, and the degree of vacuum, and is selected to be an appropriate ratio.

Each of the anode and the cathode may be formed in a layer constitution having two or more layers if needed. It is desirable that at least one surface of the organic EL device be sufficiently transparent in the luminous wavelength region of the device so that the device can efficiently emit light.

Further, the substrate for the device is also preferably transparent. The transparent electrode is produced from the above electrically conductive material by vapor deposition method, sputtering method, etc., so as to ensure a desirable transparency thereof. The electrode disposed on a light emitting surface of the device preferably has a light transmittance of 10% or more. The substrate may be glass substrate or transparent resin films being not particularly limited as long as it has a good mechanical and thermal strength as well as a good transparency. Examples of the transparent films include films of resins such as polyethylene, copolymers of ethylene and vinyl acetate, copolymers of ethylene and vinyl alcohol, polypropylene, polystyrene, polymethyl methacrylate, polyvinyl chloride, polyvinyl alcohol, polyvinyl butyral, nylon, polyether ether ketones, polysulfones, polyether sulfones, copolymers of tetrafluoroethylene and perfluoroalkyl vinyl ethers, polyvinyl fluoride, copolymers of tetrafluoroethylene and ethylene, copolymers of tetrafluoroethylene and hexafluoropropylene, poly-chlorotrifluoroethylene, polyvinylidene fluoride, polyesters, polycarbonates, polyurethanes, polyether imides, polyimides and polypropylene.

Any one of dry film forming methods such as vacuum deposition, sputtering, plasma, and ion plating; and wet film forming methods such as spin coating, dipping, and flow coating is applicable to the formation of each layer of the organic EL device according to the present invention. The thickness of each layer is not particularly limited, but must be set to an appropriate thickness. An excessively large thickness requires an increased applied voltage for obtaining certain optical output, resulting in poor efficiency. An excessively small thickness causes a pinhole or the like, so sufficient emission luminance cannot be obtained even when an electric field is applied. In general, it is preferable that the thickness of the film is in the range of 5 nm to 10 μm and more preferably in the range of 10 nm to 0.2 μm. In the wet film-forming method, materials forming the respective layers are dissolved or dispersed in a suitable solvent such as ethanol, chloroform, tetrahydrofuran and dioxane to form a thin film thereof. The solvent used for forming the respective layers is not particularly limited. Also, suitable resins or additives may be added to the respective organic thin film layers for the purposes of improving a film-forming property, preventing formation of pinholes in the resultant film, etc. Examples of the resins usable for the above purposes include insulating resins such as polystyrene, polycarbonates, polyarylates, polyesters, polyamides, polyurethanes, polysulfones, polymethyl methacrylate, polymethyl acrylate and celluloses as well as copolymers thereof, photoconductive resins such as poly-N-vinyl carbazole and polysilanes, and electrically conductive resins such as polythiophene and polypyrrole. Examples of the additive include antioxidants, ultraviolet light absorbents and plasticizers.

As described above, the use of the silicon-containing compound represented by the general formula (1) to (6) of the present invention as a light emitting material in the organic layer of an organic EL device can provide the organic EL device with high luminous efficiency, excellent heat resistance, a long lifetime, and a good color purity.

The organic EL device of the present invention can find use in applications including: a flat luminous body such as a flat panel display of a wall hanging television; a light source for the backlight, meters, or the like of a copying machine, a printer, or a liquid crystal display; a display panel; and a signal lamp.

### EXAMPLES

Hereinafter, examples of the present invention will be described more specifically. However, the present invention is not limited to those examples.

### Synthesis Example 1

### Synthesis of Compound (H-1)

Compound (H-1) was synthesized according to the following reaction formula.

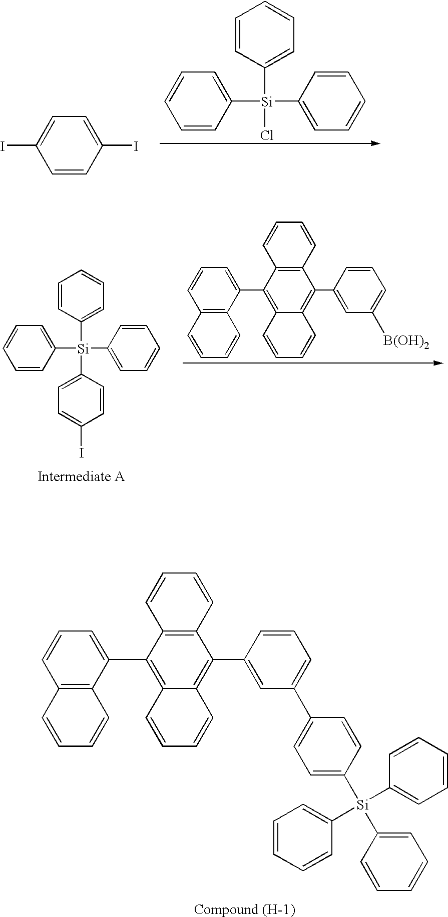

Into a 300-ml three-necked flask, 16.5 g (50 mmol) of 1,4-diiodobenzene was loaded, and air in the container was replaced with argon. Subsequently, adding 50 ml of dehydrated toluene and 50 ml of dehydrated ether, the mixture was cooled to −78° C. while stirring in a dry ice/methanol bath. Then, 20.6 ml (55 mmol) of n-butyllithium 1.6M hexane solution was dropped into the mixture solution spending 10 minutes. After stirring the solution at −20° C. for one hour, it was cooled again to −78° C. Subsequently, a solution of 16.2 g of triphenylsilyl chloride and 100 ml of dehydrated toluene was dropped spending 20 minutes, and the mixture solution was stirred for one hour allowing the solution to react each other. Then, the temperature of the resultant solution was elevated up to a room temperature, followed by stirring the solution for 2 hours. After one night, extracting with toluene/ion-exchange water, the resultant mixture solution was purified with column chromatography to obtain 15.1 g (65.4% yield) of Intermediate A.

Subsequently, allowing Intermediate A and a boronic acid of anthracene derivative synthesized in a definite process to react each other with Suzuki coupling reaction, whereby a target Compound (H-1) was obtained. A detailed description is as the following.

Into a 100-ml three-necked flask, 6.47 g (14.0 mmol) of Intermediate A, 6.80 g (14.7 mmol) of anthracene derivative boronic acid, and 0.49 g (0.42 mmol) of tetrakis(triphenylphosphine)palladium(0) were loaded, and air in the container was replaced with argon. Further, 40 ml of toluene, 40 ml of 1,2-dimethoxyethane and 21 ml (3 eq) of a 2M aqueous solution of sodium carbonate were added to the mixture, and the whole was refluxed under heat in an oil bath at 90° C. for 8 hours. After one night, extracting with toluene/ion-exchange water, the resultant mixture solution was purified with column chromatography, whereby 8.47 g (84.6% yield) of Compound (H-1) as a target product were obtained.

The resultant compound was analyzed by FD-MS (Field Desorption Mass Spectrum) and identified as H-1. The results are shown below. FD-MS calcd for C₅₄H₃₈Si=715, found m/z=715 (M⁺, 100)

### Synthesis Example 2

### Synthesis of Compound (H-2)

Compound (H-2) was synthesized according to the following reaction formula.

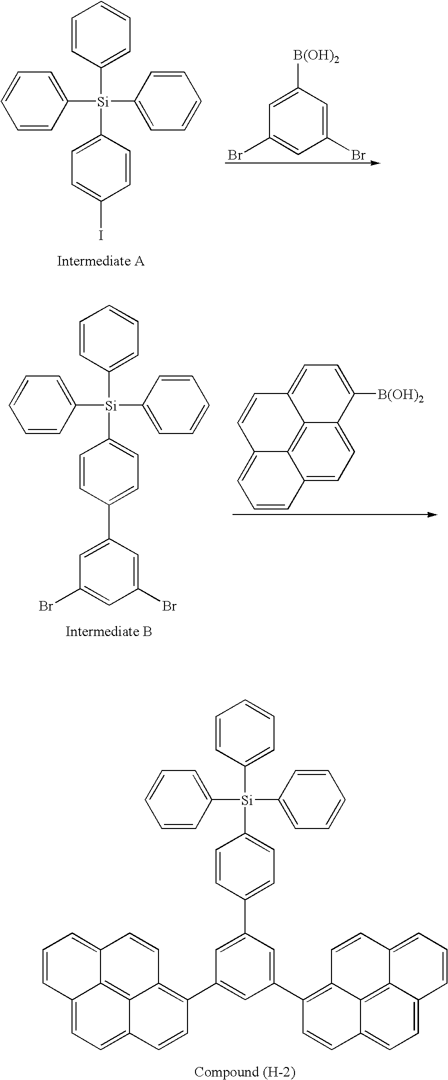

Into a 100-ml three-necked flask, 7.28 g (15.8 mmol) of Intermediate A, 4.20 g (15.0 mmol) of 3,5-dibromophenylboronic acid, and 0.35 g (0.3 mmol) of tetrakis(triphenylphosphine)palladium(0) were loaded, and air in the container was replaced with argon. Further, 50 ml of toluene and 23 ml (3 eq) of a 2M aqueous solution of sodium carbonate were added to the mixture, and the whole was refluxed under heat in an oil bath at 100° C. for 8 hours. After one night, extracting with methylene chloride/ion-exchange water, the resultant mixture solution was purified with column chromatography to obtain 7.44 g (87.0% yield) of Intermediate B.

Into a 100-ml three-necked flask, 2.85 g (5.0 mmol) of Intermediate B, 2.58 g (10.5 mmol) of 1-pyrene boronic acid, and 0.23 g (0.3 mmol) of tetrakis(triphenylphosphine)palladium(0) were loaded, and air in the container was replaced with argon. Further, 20 ml of toluene and 7.5 ml (3 eq) of a 2M aqueous solution of sodium carbonate were added to the mixture, and the whole was refluxed under heat in an oil bath at 90° C. for 8 hours. After one night, extracting with toluene/ion-exchange water, the resultant mixture solution was purified with column chromatography to obtain 3.1 g (76.1% yield) of Compound (H-2) as a target product were obtained.

The resultant compound was analyzed by FD-MS and identified as H-2. The results are shown below.

FD-MS calcd for C₆₂H₄₂Si=815, found m/z=815 (M⁺, 100)

### Synthesis Example 3

### Synthesis of Compound (H-3)

Compound (H-3) was synthesized according to the following reaction formula.

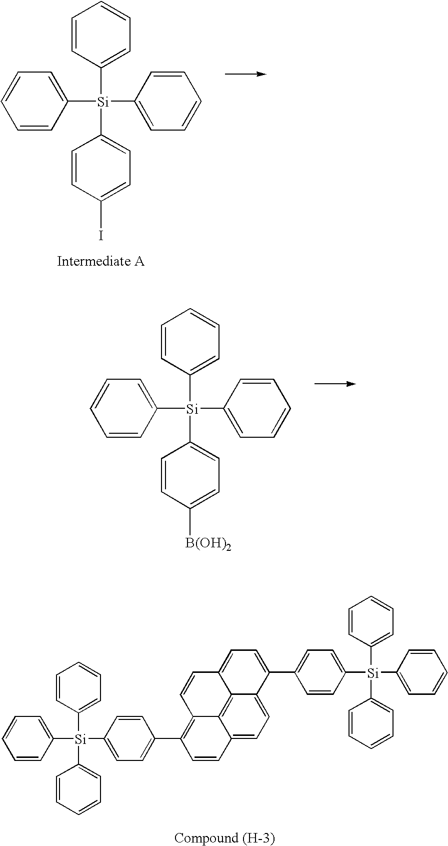

Compound (H-3) was synthesized in accordance with a definite process using Intermediate A, and the resultant compound was analyzed and identified by FD-MS. The results are shown below.

FD-MS calcd for C₆₄H₄₆Si₂=871, found m/z=871 (M⁺, 100)

### Example 1

### Fabrication and Evaluation of an Organic EL Device

A glass substrate with an ITO transparent electrode measuring 25 mm wide by 75 mm long by 1.1 mm thick (manufactured by GEOMATEC Co., Ltd.) was subjected to ultrasonic cleaning in isopropyl alcohol for 5 minutes. After that, the substrate was subjected to UV ozone cleaning for 30 minutes. The glass substrate with the transparent electrode line after the washing was mounted on a substrate holder of a vacuum vapor deposition device. First, N,N′-bis(N,N′-diphenyl-4-aminophenyl)-N,N-diphenyl-4,4′-diamino-1,1′-biphenyl film (hereinafter referred to as “TPD232 film”) was formed into a film having a thickness of 60 nm on the surface on the side where the transparent electrode line was formed to cover the transparent electrode. The TPD232 film functions as a hole injecting layer. N,N,N′,N′-tetra(4-biphenyl)-diaminobiphenylene layer (hereinafter referred to as “TBDB layer”) was formed into a film having a thickness of 20 nm on the TPD232 film. The film functions as a hole transporting layer. Further, Compound (H-1) as the host material was vapor deposited from the vapor and formed into a film having a thickness of 40 nm. Simultaneously with this formation, Amine Compound D1 having a styryl group described below, was deposited from the vapor in such a manner that a weight ratio between Compound D1 and Compound (H-1) would be 3:40. The film functions as a light emitting layer. Alq was formed into a film having a thickness of 10 nm on the resultant film. The film functions as an electron injecting layer. After that, L₁ serving as a reducing dopant (L₁ source: manufactured by SAES Getters) and Alq were subjected to co-deposition. Thus, an Alq:Li film (having a thickness of 10 nm) was formed as an electron injecting layer (cathode). Metal Al was deposited from the vapor onto the Alq:Li film to form a metal cathode. Thus, an organic EL device was formed.

Table 1 shows the results of the evaluation of the resultant organic EL device for the following items (1) and (2).

(1) Initial performance: A predetermined voltage was applied to the organic EL device, and a current value at the time of the application was measured. An emission luminance value and CIE1931 chromaticity coordinates were measured by a luminance meter (Spectroradiometer CS-1000, manufactured by Konica Minolta Sensing, Inc.) simultaneously with the measurement of the current value, followed by a calculation of current efficiency to evaluate the initial performance of the device.
(2) Lifetime: The organic EL device was driven at a constant current and initial luminance of 1,000 cd/m². The device was evaluated for its lifetime on the basis of the half time period of the luminance.

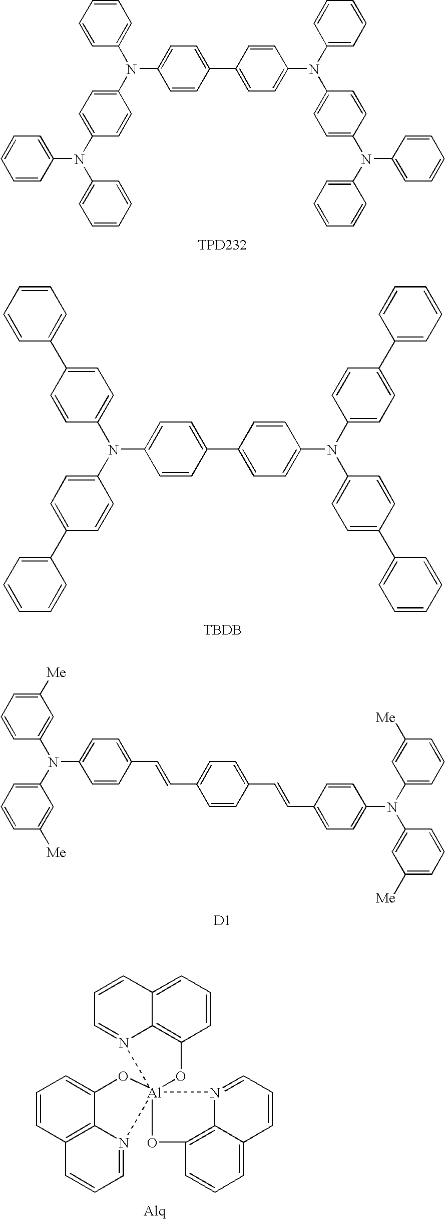

### Examples 2 to 9

Organic EL devices were fabricated in the same manner as in Example 1 except that compounds described in Table 1 were used as the light emitting material (host material) instead of Compound (H-1). The results of the evaluation in the same manners as the above are shown in Table 1.

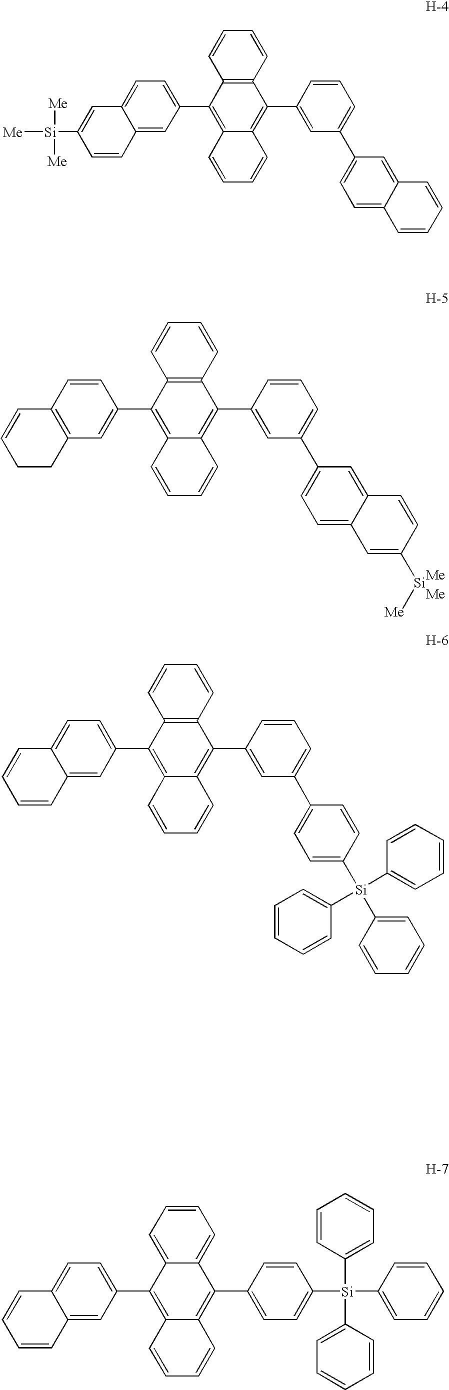

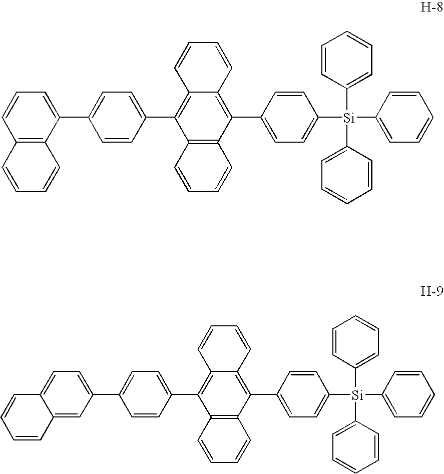

### Comparative Examples 1 to 3

Organic EL devices were fabricated in the same manner as in Example 1 except that Comparative Compounds 1 to 3 described in Table 1 were used as the light emitting material (host material) instead of Compound (H-1). The results of the evaluation in the same manners as the above are shown in Table 1.

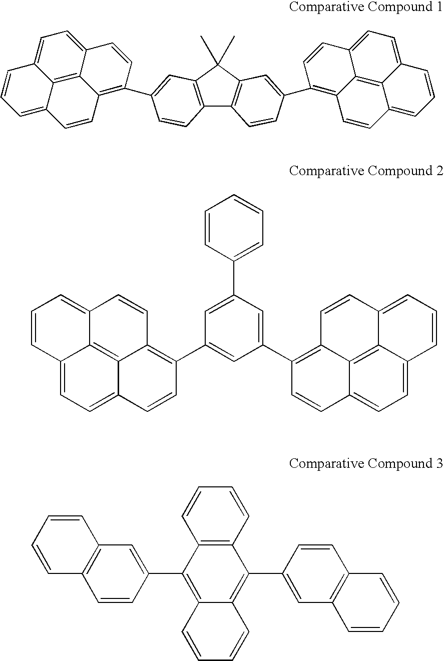

TABLE 1

| | Light | | | |
|---|---|---|---|---|
| | emitting | | | Luminescence |
| | material | | Current | half life (hours) |
| | (host | Chromaticity | efficiency | Initial |
| | material) | (CIEx, CIEy) | (cd/A) | 1000 cd/m² |
| Example 1 | H-1 | (0.14, 0.16) | 11.6 | 9250 |
| Example 2 | H-2 | (0.15, 0.17) | 10.9 | 8980 |
| Example 3 | H-3 | (0.15, 0.16) | 10.5 | 7960 |
| Example 4 | H-4 | (0.14, 0.18) | 12.1 | 9830 |
| Example 5 | H-5 | (0.15, 0.17) | 11.9 | 9810 |
| Example 6 | H-6 | (0.15, 0.18) | 11.5 | 8960 |
| Example 7 | H-7 | (0.14, 0.15) | 11.0 | 8750 |
| Example 8 | H-8 | (0.15, 0.17) | 11.2 | 8580 |
| Example 9 | H-9 | (0.15, 0.18) | 11.5 | 8260 |
| Comparative | Comparative | (0.17, 0.20) | 8.1 | 3530 |
| Example 1 | Compound 1 | | | |
| Comparative | Comparative | (0.17, 0.27) | 6.5 | 4360 |
| Example 2 | Compound 2 | | | |
| Comparative | Comparative | (0.26, 0.21) | 5.9 | 3480 |
| Example 3 | Compound 3 | | | |

As shown in Table 1, the organic EL devices including the silicon compound of Examples in the present invention provide blue light emission of higher luminous efficiency, longer lifetime and higher color purity than Comparative Examples 1 to 3.

### INDUSTRIAL APPLICABILITY

As described above in detail, the organic EL device using the silicon-containing compound of the present invention has a high luminous efficiency, a high color purity and a long lifetime. Accordingly, the device is extremely useful as the organic EL device for emitting blue light. Also, the device is extremely useful as the organic EL device for emitting white light.

1. A silicon-containing compound represented by the following general formula (1): 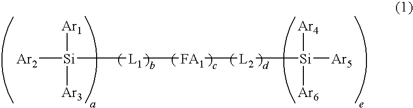
where: FA₁ represents a substituted or unsubstituted fused ring residue having 8 to 50 ring carbon atoms; L₁, L₂ and Ar₁ to Ar₆ may be independently identical to or different from each other, and independently represent a substituted or unsubstituted aromatic hydrocarbon group having 6 to 50 ring carbon atoms, a substituted or unsubstituted aromatic heterocyclic group having 3 to 50 ring carbon atoms, a substituted or unsubstituted fused aromatic group having 8 to 50 ring carbon atoms, or a substituted or unsubstituted alkyl group having 1 to 10 carbon atoms; a, b, d and e each represent an integer of 0 to 6; c represents an integer of 1 to 6; and a+e≧1; with the proviso that when FA₁ represents an anthrylene group and a=e=1, a case where L₁ and L₂ are simultaneously phenylene groups is excluded.

2. A silicon-containing compound represented by the following general formula (1): 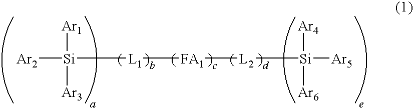
where: FA₁ represents a substituted or unsubstituted fused ring residue having 8 to 50 ring carbon atoms; L₁, L₂ and Ar₁ to Ar₆ may be independently identical to or different from each other, and independently represent a substituted or unsubstituted aromatic hydrocarbon group having 6 to 50 ring carbon atoms, a substituted or unsubstituted aromatic heterocyclic group having 3 to 50 ring carbon atoms, a substituted or unsubstituted fused aromatic group having 8 to 50 ring carbon atoms, or a substituted or unsubstituted alkyl group having 1 to 10 carbon atoms; a, b, d and e each represent an integer of 0 to 6; c represents an integer of 1 to 6; and a+e≧1; with the proviso that when FA₁ represents an anthrylene group or a naphthylene group and a=e=1, a case where L₁ and L₂ are simultaneously phenylene groups is excluded.

3. A silicon-containing compound represented by the following general formula (1): 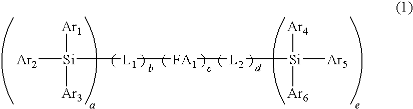
where: FA₁ represents a substituted or unsubstituted fused ring residue having 8 to 50 ring carbon atoms; L₁, L₂ and Ar₁ to Ar₆ may be independently identical to or different from each other, and independently represent a substituted or unsubstituted aromatic hydrocarbon group having 6 to 50 ring carbon atoms, a substituted or unsubstituted aromatic heterocyclic group having 3 to 50 ring carbon atoms, a substituted or unsubstituted fused aromatic group having 8 to 50 ring carbon atoms, or a substituted or unsubstituted alkyl group having 1 to 10 carbon atoms; a, b, d and e each represent an integer of 0 to 6; c represents an integer of 1 to 6; and a+e≧1; with the proviso that when FA₁ represents a fused ring residue having 8 to 20 ring carbon atoms and a=e=1, a case where L₁ and L₂ are simultaneously phenylene groups is excluded.

4. A silicon-containing compound represented by the following general formula (1): 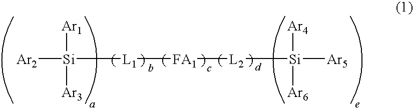
where: FA₁ represents a substituted or unsubstituted fused ring residue having 8 to 50 ring carbon atoms; L₁, L₂ and Ar₁ to Ar₆ may be independently identical to or different from each other, and independently represent a substituted or unsubstituted aromatic hydrocarbon group having 6 to 50 ring carbon atoms, a substituted or unsubstituted aromatic heterocyclic group having 3 to 50 ring carbon atoms, a substituted or unsubstituted fused aromatic group having 8 to 50 ring carbon atoms, or a substituted or unsubstituted alkyl group having 1 to 10 carbon atoms; a, b, d and e each represent an integer of 0 to 6; c represents an integer of 1 to 6; and a+e≧1; with the proviso that when FA₁ represents a fused ring residue having 8 to 20 ring carbon atoms [excluding an anthrylene group and a naphthylene group] and a=e=1, L₁ and L₂ are simultaneously phenylene groups.

5. A silicon-containing compound represented by the following general formula (1): 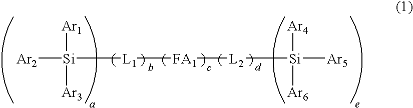
where: FA₁ represents a substituted or unsubstituted fused ring residue having 8 to 50 ring carbon atoms; L₁, L₂ and Ar₁ to Ar₆ may be independently identical to or different from each other, and independently represent a substituted or unsubstituted aromatic hydrocarbon group having 6 to 50 ring carbon atoms, a substituted or unsubstituted aromatic heterocyclic group having 3 to 50 ring carbon atoms, a substituted or unsubstituted fused aromatic group having 8 to 50 ring carbon atoms, or a substituted or unsubstituted alkyl group having 1 to 10 carbon atoms; a, b, d and e each represent an integer of 0 to 6; c represents an integer of 1 to 6; and a+e≧1; with the proviso that when FA₁ represents a pyrenylene group and a=e=1, L₁ and L₂ are simultaneously phenylene groups.

6. The silicon-containing compound according to claim 1, which is represented by the following general formula (2): 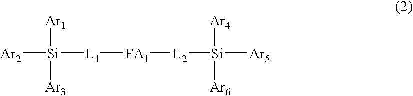
where: FA₁, L₁, L₂ and Ar₁ to Ar₆ each independently have the same meaning as those described above.

7. The silicon-containing compound according to claim 1, which is represented by the following general formulae (3) to (6): 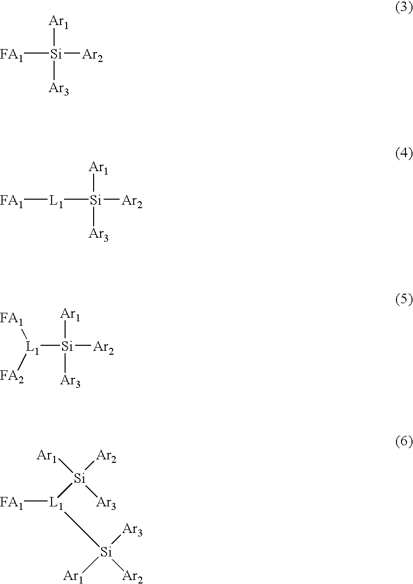
where: FA₁ and FA₂ each independently have the same meaning as FA₁ described above; and L₁ and Ar₁ to Ar₃ each independently have the same meaning as those described above.

8. The silicon-containing compound according to claim 7, wherein the fused ring residue having 8 to 50 ring carbon atoms represented by at least one of FA₁ and FA₂ is a residue of a compound having a skeleton of naphthalene, phenanthrene, pyrene, anthracene, tetracene, coronene, chrysene, fluorene, perylene, benzanthracene, pentacene, dibenzo anthracene, benzopyrene, benzofluorene, fluoranthene, benzofluoranthene, naphthyl fluoranthene, dibenzofluorene, dibenzopyrene, dibenzofluoranthene, naphthacene or acenaphthyl fluoranthene.

9. The silicon-containing anthracene derivative according to claim 1, wherein the fused ring residue having 8 to 50 ring carbon atoms represented by FA₁ in the general formula (1) corresponds to a residue of a compound having an anthracene skeleton, with the proviso that when a=e=1, a case where L₁ and L₂ are simultaneously phenylene groups is excluded.

10. The silicon-containing anthracene derivative according to claim 7, wherein the fused ring residue having 8 to 50 ring carbon atoms represented by at least one of FA₁ and FA₂ in the general formulae (2) to (6) corresponds to a residue of a compound having an anthracene skeleton, with the proviso that a case where L₁ and L₂ in the general formula (2) are simultaneously phenylene groups is excluded.

11. The silicon-containing anthracene derivative according to claim 1, wherein the following partial structure (A) in the general formula (1) corresponds to a residue of the following general formula (7): 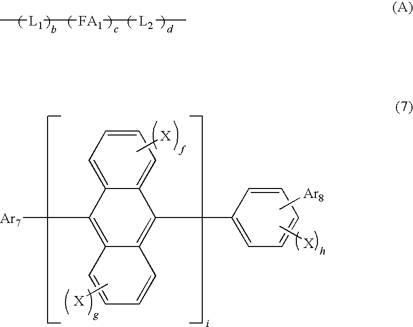
where:
X's may be independently identical to or different from each other and X represents a single bond, a hydrogen atom, a substituted or unsubstituted aromatic hydrocarbon group having 6 to 50 ring carbon atoms, a substituted or unsubstituted aromatic heterocyclic group having 5 to 50 ring atoms, a substituted or unsubstituted alkyl group having 1 to 50 carbon atoms, a substituted or unsubstituted cycloalkyl group having 3 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 carbon atoms, a substituted or unsubstituted arylthio group having 5 to 50 carbon atoms, a substituted or unsubstituted alkoxycarbonyl group having 1 to 50 carbon atoms, a substituted or unsubstituted silyl group, a carboxyl group, a halogen atom, a cyano group, a nitro group or a hydroxyl group;
Ar₇ and Ar₈ may be independently identical to or different from each other, and each independently represent a substituted or unsubstituted aromatic hydrocarbon group having 6 to 50 ring carbon atoms, or a substituted or unsubstituted fused aromatic group having 8 to 50 ring carbon atoms; and when they each represents the fused aromatic group having 8 to 50 ring carbon atoms, they each correspond to either a 1-naphthyl group represented by the following general formula (B) or a 2-naphthyl group represented by the following general formula (C): 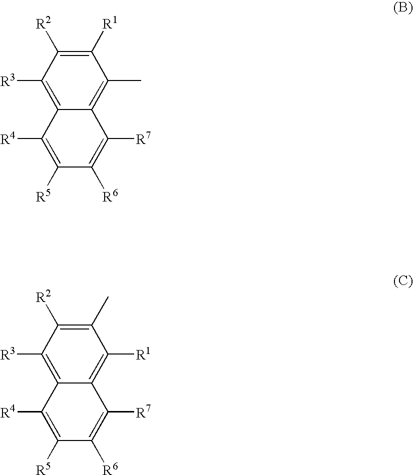
where: R¹ to R⁷ may be independently identical to or different from each other, and each represent a single bond, a hydrogen atom or a substituted or unsubstituted alkyl group having 1 to 50 carbon atoms;
f, g, and h each independently represent an integer of 0 to 4; i represents an integer of 1 to 3; with the proviso that when i is an integer of 2 or greater, the plural groups within square brackets ([ ]) may be identical to or different from each other and that when a=e=1 in the general formula (1), a case where Ar₇ corresponds to phenylene group is excluded.

12. The silicon-containing anthracene derivative according to claim 1, wherein the following partial structure (A) in the general formula (1) corresponds to a residue of the following general formula (8): 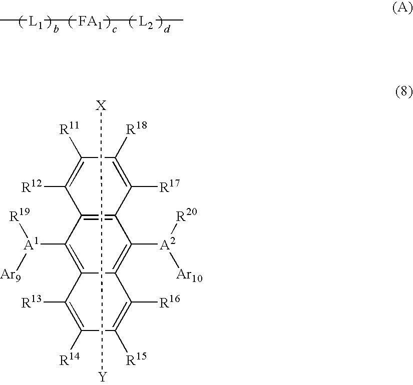
where:
A¹ and A² may be independently identical to or different from each other, and each independently represent a substituted or unsubstituted aromatic hydrocarbon group having 6 to 50 ring carbon atoms, or a substituted or unsubstituted fused aromatic group having 8 to 50 ring carbon atoms;
Ar₉ and Ar₁₀ may be independently identical to or different from each other; and each independently represent a single bond, a hydrogen atom, a substituted or unsubstituted aromatic hydrocarbon group having 6 to 50 ring carbon atoms, or a substituted or unsubstituted fused aromatic group having 8 to 50 ring carbon atoms;
R¹¹ to R²⁰ may be independently identical to or different from each other, and each independently represent a single bond, a hydrogen atom, a substituted or unsubstituted aromatic hydrocarbon group having 6 to 50 ring carbon atoms, a substituted or unsubstituted aromatic heterocyclic group having 5 to 50 ring atoms, a substituted or unsubstituted alkyl group having 1 to 50 carbon atoms, a substituted or unsubstituted cycloalkyl group having 3 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 ring atoms, a substituted or unsubstituted arylthio group having 5 to 50 ring atoms, a substituted or unsubstituted alkoxycarbonyl group having 1 to 50 carbon atoms, a substituted or unsubstituted silyl group, a carboxyl group, a halogen atom, a cyano group, a nitro group or a hydroxyl group;
Ar₉, Ar₁₀, R¹⁹ and R²⁰ may exist in plural numbers respectively; with the proviso that, when a=e=1 in the general formula (1), the groups at 9- and 10-positions of the central anthracene are not symmetrical with respect to the X-Y axis in the general formula (8).

13. The silicon-containing pyrene derivative according to claim 3, wherein the fused ring residue having 8 to 50 ring carbon atoms represented by FA₁ in the general formula (1) corresponds to a residue of a compound having a pyrene skeleton, with the proviso that when a=e=1, a case where L₁ and L₂ are simultaneously phenylene groups is excluded.

14. The silicon-containing pyrene derivative according to claim 7, wherein the fused ring residue having 8 to 50 ring carbon atoms represented by at least one of FA₁ and FA₂ in the general formulae (2) to (6) corresponds to a residue of a compound having a pyrene skeleton, with the proviso that a case where L₁ and L₂ in the general formula (2) are simultaneously phenylene groups is excluded.

15. The silicon-containing pyrene derivative according to claim 3, wherein the following partial structure (A) in the general formula (1) corresponds to a residue of the following general formula (9): 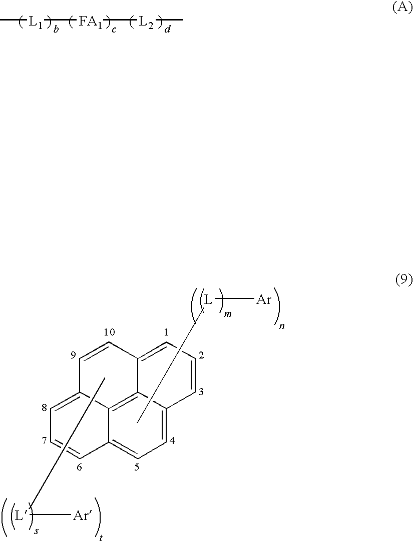
where:
L, L₁, Ar and Ar′ may be independently identical to or different from each other and each independently represent a single bond, a hydrogen atom, a substituted or unsubstituted aromatic hydrocarbon group having 6 to 50 ring carbon atoms, a substituted or unsubstituted aromatic heterocyclic group having 5 to 50 ring atoms, a substituted or unsubstituted fused aromatic group having 8 to 50 ring carbon atoms, a substituted or unsubstituted alkyl group having 1 to 50 carbon atoms, a substituted or unsubstituted cycloalkyl group having 3 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 carbon atoms, a substituted or unsubstituted arylthio group having 5 to 50 carbon atoms, a substituted or unsubstituted alkoxycarbonyl group having 1 to 50 carbon atoms, a substituted or unsubstituted silyl group, a carboxyl group, a halogen atom, a cyano group, a nitro group or a hydroxyl group; m and s each independently represent an integer 0 to 2, n and t each independently represents an integer of 0 to 4;
L or Ar is bonded to any one of 1- to 5-positions of pyrene ring; and L′ or Ar′ is bonded to any one of 6- to 10-positions of pyrene ring; and further,
(L)ₘ-Ar bonded to any one of 1- to 5-positions of pyrene ring and (L′)ₛ-Ar′ bonded to any one of 6- to 10-positions of pyrene ring may be identical to or different from each other; with the proviso that when a=e=1 in the general formula (1), a case where (L)ₘ-Ar and (L′)ₛ-Ar′ in the general formula (9) are simultaneously phenylene groups is excluded.

16. The silicon-containing pyrene derivative according to claim 5, wherein the fused ring residue having 8 to 50 ring carbon atoms represented by FA₁ in the general formula (1) corresponds to a residue of a compound having a pyrene skeleton, with the proviso that when a=e=1, L₁ and L₂ are simultaneously phenylene groups.

17. The silicon-containing pyrene derivative according to claim 7, wherein the fused ring residue having 8 to 50 ring carbon atoms represented by at least one of FA₁ and FA₂ in the general formulae (2) to (6) corresponds to a residue of a compound having a pyrene skeleton, with the proviso that L₁ and L₂ in the general formula (2) are simultaneously phenylene groups.

18. The silicon-containing pyrene derivative according to claim 5, wherein the following partial structure (A) in the general formula (1) corresponds to a residue of the following general formula (9): 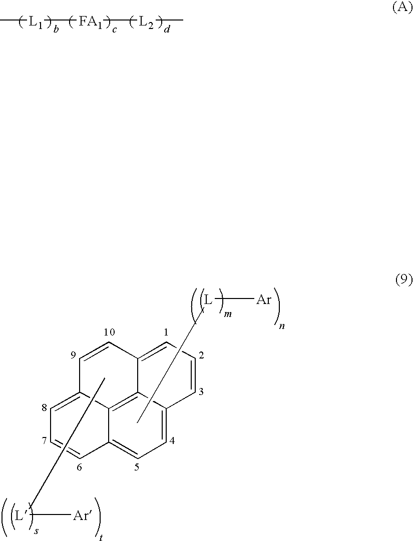
where:
L, L′, Ar and Ar′ may be independently identical to or different from each other and each independently represent a single bond, a hydrogen atom, a substituted or unsubstituted aromatic hydrocarbon group having 6 to 50 ring carbon atoms, a substituted or unsubstituted aromatic heterocyclic group having 5 to 50 ring atoms, a substituted or unsubstituted fused aromatic group having 8 to 50 ring carbon atoms, a substituted or unsubstituted alkyl group having 1 to 50 carbon atoms, a substituted or unsubstituted cycloalkyl group having 3 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 atoms, a substituted or unsubstituted arylthio group having 5 to 50 carbon atoms, a substituted or unsubstituted alkoxycarbonyl group having 1 to 50 carbon atoms, a substituted or unsubstituted silyl group, a carboxyl group, a halogen atom, a cyano group, a nitro group or a hydroxyl group;
m and s each independently represents an integer 0 to 2, n and t each independently represent an integer 0 to 4;
L or Ar is bonded to any one of 1- to 5-positions of pyrene ring; and L′ or Ar′ is bonded to any one of 6- to 10-positions of pyrene ring; and further,
(L)ₘ-Ar bonded to any one of 1- to 5-positions of pyrene ring and (L′)ₛ-Ar′ bonded to any one of 6- to 10-positions of pyrene ring may be identical to or different from each other; with the proviso that when a=e=1 in the general formula (1), (L)ₘ-Ar and (L′)ₛ-Ar′ in the general formula (9) are simultaneously phenylene groups.

19. An organic electroluminescence device comprising one or more organic thin film layers including at least one light emitting layer interposed between a cathode and an anode, wherein at least one of the organic thin film layers comprises the silicon-containing compound according to claim 1 alone or as a component of a mixture.

20. The electroluminescence device according to claim 19, wherein the light emitting layer comprises the silicon-containing compound as a light emitting material.

21. The electroluminescence device according to claim 19, wherein the light emitting layer comprises the silicon-containing compound as a host material.

22. An organic electroluminescence device, comprising one or more organic thin film layers including at least one light emitting layer interposed between a cathode and an anode, wherein at least one of the organic thin film layers comprises the silicon-containing anthracene derivative according to claim 9 alone or as a component of a mixture.

23. The electroluminescence device according to claim 22, wherein the light emitting layer comprises the silicon-containing anthracene derivative as a light emitting material.

24. The electroluminescence device according to claim 22, wherein the light emitting layer comprises the silicon-containing anthracene derivative as a host material.

25. An organic electroluminescence device, comprising one or more organic thin film layers including at least one light emitting layer interposed between a cathode and an anode, wherein at least one of the organic thin film layers comprises the silicon containing pyrene derivative according to claim 13 alone or as a component of a mixture.

26. The electroluminescence device according to claim 25, wherein the light emitting layer comprises the silicon-containing pyrene derivative as a light emitting material.

27. The electroluminescence device according to claim 25, wherein the light emitting layer comprises the silicon-containing pyrene derivative as a host material.

28. The organic electroluminescence device according to claim 19, wherein the light emitting layer further comprises a fluorescent dopant or a phosphorescent dopant.

29. The organic electroluminescence device according to claim 28, wherein the light emitting layer comprises at least one of an arylamine compound and an aryl diamine compound.

30. The organic electroluminescence device according to claim 29, wherein the light emitting layer comprises at least one of a styryl amine compound and a styryl diamine compound.

31. The organic electroluminescence device according to claim 29, wherein the light emitting layer comprises at least one of an aromatic amine compound and an aromatic diamine compound.

32. The organic electroluminescence device according to claim 29, wherein the light emitting layer comprises a fused heterocyclic aromatic compound (excluding an amine compound).

33. The organic electroluminescence device according to claim 28, wherein the light emitting layer comprises a metal-complex compound.

34. The silicon-containing compound according to claim 2, which is represented by the following general formula (2): 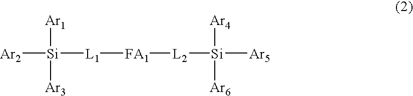
where: FA₁, L₁, L₂ and Ar₁ to Ar₆ each independently have the same meaning as those described above.

35. The silicon-containing compound according to claim 3, which is represented by the following general formula (2): 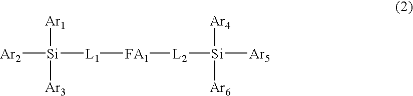
where: FA₁, L₁, L₂ and Ar₁ to Ar₆ each independently have the same meaning as those described above.

36. The silicon-containing compound according to claim 4, which is represented by the following general formula (2): 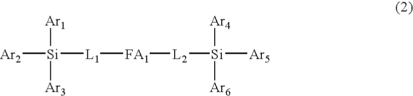
where: FA₁, L₁, L₂ and Ar₁ to Ar₆ each independently have the same meaning as those described above.

37. The silicon-containing compound according to claim 5, which is represented by the following general formula (2): 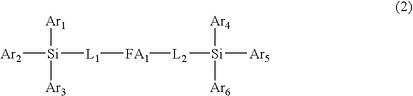
where: FA₁, L₁, L₂ and Ar₁ to Ar₆ each independently have the same meaning as those described above.

38. The silicon-containing compound according to claim 2, which is represented by the following general formulae (3) to (6): 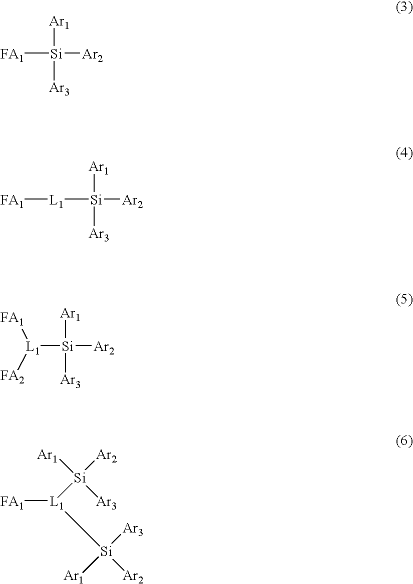
where: FA₁ and FA₂ each independently have the same meaning as FA₁ described above; and L₁ and Ar₁ to Ar₃ each independently have the same meaning as those described above.

39. The silicon-containing compound according to claim 38, wherein the fused ring residue having 8 to 50 ring carbon atoms represented by at least one of FA₁ and FA₂ is a residue of a compound having a skeleton of naphthalene, phenanthrene, pyrene, anthracene, tetracene, coronene, chrysene, fluorene, perylene, benzanthracene, pentacene, dibenzo anthracene, benzopyrene, benzofluorene, fluoranthene, benzofluoranthene, naphthyl fluoranthene, dibenzofluorene, dibenzopyrene, dibenzofluoranthene, naphthacene or acenaphthyl fluoranthene.

40. The silicon-containing compound according to claim 3, which is represented by the following general formulae (3) to (6): 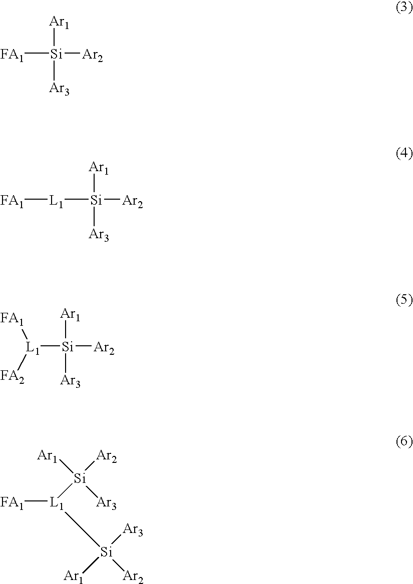
where: FA₁ and FA₂ each independently have the same meaning as FA₁ described above; and L₁ and Ar₁ to Ar₃ each independently have the same meaning as those described above.

41. The silicon-containing compound according to claim 40, wherein the fused ring residue having 8 to 50 ring carbon atoms represented by at least one of FA₁ and FA₂ is a residue of a compound having a skeleton of naphthalene, phenanthrene, pyrene, anthracene, tetracene, coronene, chrysene, fluorene, perylene, benzanthracene, pentacene, dibenzo anthracene, benzopyrene, benzofluorene, fluoranthene, benzofluoranthene, naphthyl fluoranthene, dibenzofluorene, dibenzopyrene, dibenzofluoranthene, naphthacene or acenaphthyl fluoranthene.

42. The silicon-containing compound according to claim 4, which is represented by the following general formulae (3) to (6): 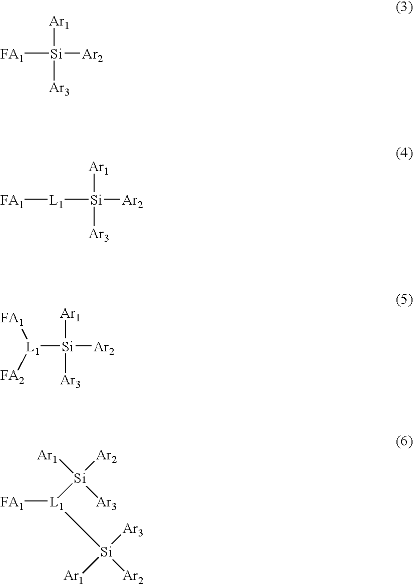
where: FA₁ and FA₂ each independently have the same meaning as FA₁ described above; and L₁ and Ar₁ to Ar₃ each independently have the same meaning as those described above.

43. The silicon-containing compound according to claim 42, wherein the fused ring residue having 8 to 50 ring carbon atoms represented by at least one of FA₁ and FA₂ is a residue of a compound having a skeleton of naphthalene, phenanthrene, pyrene, anthracene, tetracene, coronene, chrysene, fluorene, perylene, benzanthracene, pentacene, dibenzo anthracene, benzopyrene, benzofluorene, fluoranthene, benzofluoranthene, naphthyl fluoranthene, dibenzofluorene, dibenzopyrene, dibenzofluoranthene, naphthacene or acenaphthyl fluoranthene.

44. The silicon-containing compound according to claim 5, which is represented by the following general formulae (3) to (6): 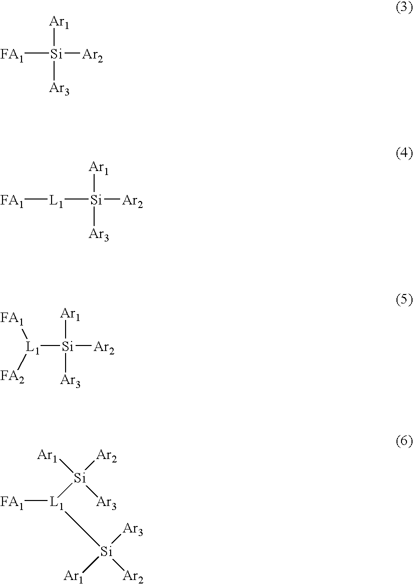
where: FA₁ and FA₂ each independently have the same meaning as FA₁ described above; and L₁ and Ar₁ to Ar₃ each independently have the same meaning as those described above.

45. The silicon-containing compound according to claim 44, wherein the fused ring residue having 8 to 50 ring carbon atoms represented by at least one of FA₁ and FA₂ is a residue of a compound having a skeleton of naphthalene, phenanthrene, pyrene, anthracene, tetracene, coronene, chrysene, fluorene, perylene, benzanthracene, pentacene, dibenzo anthracene, benzopyrene, benzofluorene, fluoranthene, benzofluoranthene, naphthyl fluoranthene, dibenzofluorene, dibenzopyrene, dibenzofluoranthene, naphthacene or acenaphthyl fluoranthene.

46. An organic electroluminescence device comprising one or more organic thin film layers including at least one light emitting layer interposed between a cathode and an anode, wherein at least one of the organic thin film layers comprises the silicon-containing compound according to claim 2 alone or as a component of a mixture.

47. An organic electroluminescence device comprising one or more organic thin film layers including at least one light emitting layer interposed between a cathode and an anode, wherein at least one of the organic thin film layers comprises the silicon-containing compound according to claim 3 alone or as a component of a mixture.

48. An organic electroluminescence device comprising one or more organic thin film layers including at least one light emitting layer interposed between a cathode and an anode, wherein at least one of the organic thin film layers comprises the silicon-containing compound according to claim 4 alone or as a component of a mixture.

49. An organic electroluminescence device comprising one or more organic thin film layers including at least one light emitting layer interposed between a cathode and an anode, wherein at least one of the organic thin film layers comprises the silicon-containing compound according to claim 5 alone or as a component of a mixture.

50. An organic electroluminescence device comprising one or more organic thin film layers including at least one light emitting layer interposed between a cathode and an anode, wherein at least one of the organic thin film layers comprises the silicon-containing compound according to claim 6 alone or as a component of a mixture.

51. An organic electroluminescence device comprising one or more organic thin film layers including at least one light emitting layer interposed between a cathode and an anode, wherein at least one of the organic thin film layers comprises the silicon-containing compound according to claim 7 alone or as a component of a mixture.

52. An organic electroluminescence device comprising one or more organic thin film layers including at least one light emitting layer interposed between a cathode and an anode, wherein at least one of the organic thin film layers comprises the silicon-containing compound according to claim 8 alone or as a component of a mixture.

53. An organic electroluminescence device, comprising one or more organic thin film layers including at least one light emitting layer interposed between a cathode and an anode, wherein at least one of the organic thin film layers comprises the silicon-containing anthracene derivative according to claim 10 alone or as a component of a mixture.

54. An organic electroluminescence device, comprising one or more organic thin film layers including at least one light emitting layer interposed between a cathode and an anode, wherein at least one of the organic thin film layers comprises the silicon-containing anthracene derivative according to claim 11 alone or as a component of a mixture.

55. An organic electroluminescence device, comprising one or more organic thin film layers including at least one light emitting layer interposed between a cathode and an anode, wherein at least one of the organic thin film layers comprises the silicon-containing anthracene derivative according to claim 12 alone or as a component of a mixture.

56. An organic electroluminescence device, comprising one or more organic thin film layers including at least one light emitting layer interposed between a cathode and an anode, wherein at least one of the organic thin film layers comprises the silicon containing pyrene derivative according to claim 14 alone or as a component of a mixture.

57. An organic electroluminescence device, comprising one or more organic thin film layers including at least one light emitting layer interposed between a cathode and an anode, wherein at least one of the organic thin film layers comprises the silicon containing pyrene derivative according to claim 15 alone or as a component of a mixture.

58. An organic electroluminescence device, comprising one or more organic thin film layers including at least one light emitting layer interposed between a cathode and an anode, wherein at least one of the organic thin film layers comprises the silicon containing pyrene derivative according to claim 16 alone or as a component of a mixture.

59. An organic electroluminescence device, comprising one or more organic thin film layers including at least one light emitting layer interposed between a cathode and an anode, wherein at least one of the organic thin film layers comprises the silicon containing pyrene derivative according to claim 17 alone or as a component of a mixture.

60. An organic electroluminescence device, comprising one or more organic thin film layers including at least one light emitting layer interposed between a cathode and an anode, wherein at least one of the organic thin film layers comprises the silicon containing pyrene derivative according to claim 18 alone or as a component of a mixture.

61. The organic electroluminescence device according to claim 22, wherein the light emitting layer further comprises a fluorescent dopant or a phosphorescent dopant.

62. The organic electroluminescence device according to claim 25, wherein the light emitting layer further comprises a fluorescent dopant or a phosphorescent dopant.
